(19) United States
(12) Patent Application Publication
(10) Pub. No.: US 2012/0226890 A1
(43) Pub. Date: Sep. 6, 2012

(54) ACCELERATOR AND DATA PROCESSING METHOD

(75) Inventors: Hiroaki Yoshida, Tokyo (JP); Masahiro Fujita, Tokyo (JP)

(73) Assignee: The University of Tokyo, Tokyo (JP)

(21) Appl. No.: 13/403,500

(22) Filed: Feb. 23, 2012

Related U.S. Application Data
(60) Provisional application No. 61/446,208, filed on Feb. 24, 2011.

(51) Int. Cl. G06F 15/76

(52) U.S. Cl. 712/1

(57) ABSTRACT

The process speed and the power efficiency are improved while accomplishing downsizing by configuring an integrated hard-wired logic controller by a hard-wired logic, and a function modification is enabled by a patch circuit without re-designing of the integrated hard-wired logic controller itself by high-level synthesis even when the function modification becomes necessary because of a specification change and a false design after the production. The costs can be reduced by what corresponds to the unnecessity of re-designing. Therefore, an accelerator is provided which can improve the process speed and the power efficiency while accomplishing downsizing, and which can remarkably reduce the costs for the function modification after the production.

### BACKGROUND OF THE INVENTION

1. Field of the Invention

The present invention relates to an accelerator and a data processing method, and is appropriate when applied to an accelerator with a possibility of needing a function modification after production.

2. Description of the Related Art

In recent system-on-chip (SoC: System on a Chip) development, introduction of a method (hereinafter, referred to as a high-level synthesis method) of designing an accelerator through a high-level synthesis is advanced together with the increase of a development cost and the reduction of the development period (see, for example, JP H05-101141 A). The high-level synthesis is a technology of producing an RTL (Register Transfer Level) logic circuit from action descriptions describing a processing operation by a hardware.

An accelerator produced based on the high-level synthesis is configured by a circuit dedicated for a specific function, has no extra circuit configuration and is compact in comparison with a general-purpose processor with a high programmability that enables a function modification after production, has a fast process speed, and can reduce the power consumption. Hence, an accelerator with a fixed function is designed individually and utilized in various fields needing both high performance and high efficiency although a cost at the time of designing is high due to the high-level synthesis.

Meanwhile, an accelerator produced through the high-level synthesis may need a modification of a circuit configuration after production in some cases because of a specification change and a false design of the accelerator. In this case, it is necessary to newly design an accelerator through the high-level synthesis to redesign the accelerator having undergone a function modification and to produce the accelerator again. Hence, a high cost occurs again.

Conversely, a general-purpose processor with a programmability allows easy modification of a function after production by merely changing a program without the high-level synthesis, and thus enables the function modification at a low cost, but the whole control circuit is configured by a memory, and thus an extremely large-capacity memory is requisite. Accordingly, such a processor is large in size in comparison with an accelerator having a control circuit configured by a hard-wired logic and has a slow process speed because of the extra memory, etc., and has a poor power efficiency. As explained above, the general-purpose processors can reduce the costs necessary for the function modification after production, but has a poor performance in comparison with an accelerator with a fixed function.

The present invention has been made in view of the above-explained circumstance, and it is an object of the present invention to provide an accelerator and a data processing method which enable downsizing, improve the process speed and the power efficiency, and are capable of dramatically reducing costs necessary for a function modification after production.

### SUMMARY OF THE INVENTION

To achieve the object, a first aspect of the present invention provides an accelerator that includes: a control unit including a controller which is configured by a hard-wired logic with a prefixed logic, and which successively generates control signals that are instructions of predetermined arithmetic processing in accordance with a preset order of program counters; and a data path that executes an operation in accordance with the arithmetic processing instruction through a plurality of function units based on the control signal from the control unit, the control unit further including a patch circuit which replaces a predetermined program counter in the program counters with an additional program counter, and which transmits, to the data path, a control signal that is an modified arithmetic processing instruction associated with the additional program counter instead of the arithmetic processing instruction associated with the predetermined program counter, and the data path is configured to execute an operation in accordance with the modified arithmetic processing instruction upon reception of the control signal from the patch circuit.

According to a second aspect of the present invention, the patch circuit includes: a program counter patch that is capable of storing the additional program counter instead of a program counter to be executed next and associated with the program counter; and a control signal patch that is capable of storing the modified arithmetic processing instruction associated with the additional program counter, the program counter patch successively receives the program counter to be executed next from the controller, and transmits, to the control signal patch, the additional program counter instead of the program counter when the program counter is a program counter to be replaced with the additional program counter, and the control signal patch transmits the control signal that is the modified arithmetic processing instruction associated with the additional program counter to the data path.

According to a third aspect of the present invention, the patch circuit includes a memory that stores the modified arithmetic processing instruction, and repeatedly generates control signals by predetermined times in a loop in a predetermined order defined by the program counters and the additional program counter, and the memory is coupled to a patch memory, reads another modified arithmetic processing instruction different from the modified arithmetic processing instruction as needed from the patch memory, and generates a control signal indicating the another modified arithmetic processing instruction instead of the modified arithmetic processing instruction during the looped process.

According to a fourth aspect of the present invention, the controller employs a circuit configuration that enables a plurality of different functions.

According to a fifth aspect of the present invention, the data path is provided with, in addition to the function unit that is capable of executing an arithmetic processing in accordance with the control signal from the controller, an auxiliary function unit to be necessary to satisfy a performance constraint after a function modification performed on the control unit.

According to a sixth aspect of the present invention, a virtual arithmetic processing to be executed based on the control signal from the control unit is changed within a predetermined range at random, and the data path is provided with the auxiliary function unit necessary to execute the changed virtual arithmetic processing.

According to a seventh aspect of the present invention, virtual change of the arithmetic processing is executed by predetermined times, and the data path is provided with all of the auxiliary function units necessary for executing respective virtual arithmetic processing.

According to an eighth aspect of the present invention, the accelerator further includes: a plurality of distributed registers associated in advance with respective function units each executing the arithmetic processing; and a register file coupled with all of the function units, in which an operation result obtained by the function unit is stored in the distributed register associated with the function unit, and when an arithmetic processing through the auxiliary function unit other than the function unit is necessary, an operation result obtained by the auxiliary function unit is stored in the register file.

According to a ninth aspect of the present invention, the accelerator further includes a trace buffer that can store trace information which is the arithmetic processing instruction associated with the predetermined program counter among the program counters.

A tenth aspect of the present invention provides a data processing method executed by an accelerator, the accelerator including: a control unit including a controller which is configured by a hard-wired logic with a prefixed logic, and which successively generates control signals that are instructions of predetermined arithmetic processing in accordance with a preset order of program counters; and a data path that executes an operation in accordance with the arithmetic processing instruction through a function unit based on the control signal from the control unit, the data processing method including: a replacement step of causing a patch circuit provided in the control unit to replace a predetermined program counter in the program counters with an additional program counter; a transmission step of causing the patch circuit to transmit a control signal that is a modified arithmetic processing instruction associated with the additional program counter to the data path instead of an arithmetic processing instruction associated with the program counter replaced with the additional program counter; and an execution step of causing the data path to execute an operation in accordance with the modified arithmetic processing instruction.

According to an eleventh aspect of the present invention, in the replacement step, when a program counter patch provided in the patch circuit determines that the program counter to be executed next and received from the controller is the program counter to be replaced with the additional program counter, the additional program counter is transmitted to a control signal patch provided in the patch circuit instead of the program counter to be replaced, in the transmission step, the control signal patch reads the modified arithmetic processing instruction associated with the additional program counter from a memory, and transmits the read modified arithmetic processing instruction as the control signal to the data patch.

According to a twelfth aspect of the present invention, the data processing method repeats the replacement step, the transmission step and the execution step in a loop, reads another modified arithmetic processing instruction different from the modified arithmetic processing instruction as needed from a patch memory, stores the read another modified arithmetic processing instruction in the memory, and generates a control signal indicating the another modified arithmetic processing instruction during the looped process instead of the modified arithmetic processing instruction.

According to a thirteenth aspect of the present invention, the controller comprises a circuit configuration enabling a plurality of different functions, and realizes a predetermined function as needed.

According to a fourteenth aspect of the present invention, the data path executes the arithmetic processing through an auxiliary function unit to be necessary to satisfy a performance constraint after a function modification performed on the control unit in addition to a function unit capable of executing an arithmetic processing based on the control signal from the controller.

According to a fifteenth aspect of the present invention, a virtual arithmetic process to be executed based on the control signal from the control unit is changed within a predetermined range at random, and the auxiliary function unit provided for executing the changed virtual arithmetic processing executes the operation in accordance with the modified arithmetic processing instruction.

According to a sixteenth aspect of the present invention, virtual change of the arithmetic processing is executed by predetermined times, and the auxiliary function unit provided for executing each virtual arithmetic processing executes the operation in accordance with the modified arithmetic processing instruction.

According to the first aspect of the present invention, the downsizing and improvement of the process speed and the power efficiency are accomplished by configuring a controller by a hard-wired logic, and even if a function modification is necessary after production because of a specification change and a false design, the function modification can be made by a patch circuit without a redesigning of the controller itself through a high-level synthesis, and thus the costs can be reduced by what corresponds to such a scheme of function modification. Accordingly, an accelerator can be provided which enables downsizing, improves the process speed and the power efficiency, and is capable of dramatically reducing costs necessary for the function modification after production.

According to the tenth aspect of the present invention, the downsizing and improvement of the process speed and the power efficiency are accomplished by configuring a controller by a hard-wired logic, and a function modification can be made by a patch circuit without a redesigning of a controller itself through a high-level synthesis, thereby reducing costs by what corresponds to such a scheme of function modification. Accordingly, a data processing method can be provided which enables downsizing, improves the process speed and the power efficiency, and is capable of dramatically reducing costs necessary for the function modification after production.

### BRIEF DESCRIPTION OF THE DRAWINGS

FIG. 1 is a block diagram showing a circuit configuration of an accelerator;

FIG. 2 is a block diagram showing a circuit configuration of an integrated hard-wired logic controller;

FIG. 3A is a schematic view showing a data flow graph designed initially;

FIG. 3B shows a schedule of the data flow graph shown in FIG. 3A;

FIG. 4A is a schematic view showing a data flow graph having undergone a function modification;

FIG. 4B shows a schedule of the data flow graph shown in FIG. 4A;

FIG. 5 is a block diagram showing a circuit configuration of a patch circuit;

FIG. 6 is a schematic view for explaining the outline of a data path synthesis method;

FIG. 7A is a schematic view for explaining a generation of modified data flow graph from a data flow graph;

FIG. 7B is a schematic view for explaining a generation of modified data flow graph from a data flow graph;

FIG. 7C is a schematic view for explaining a generation of modified data flow graph from a data flow graph;

FIG. 8 is a schematic view for explaining a procedure of scheduling;

FIG. 9 is a schematic view for explaining a procedure of binding;

FIG. 10 is a schematic view showing an illustrative data flow graph;

FIG. 11A is a schematic view showing a result (1) of scheduling-binding;

FIG. 11B is a schematic view showing a result (1) of scheduling-binding;

FIG. 12A is a schematic view showing a result (2) of scheduling-binding;

FIG. 12B is a schematic view showing a result (2) of scheduling-binding;

FIG. 13 is a schematic view showing a function modification of an accelerator of the present invention in comparison with a function modification of a prior-art accelerator;

FIG. 14 is a schematic view for explaining a process from a production of an accelerator to a function modification;

FIG. 15 is a schematic view showing a whole area of an integrated circuit using an accelerator of the present invention in comparison with a prior-art integrated circuit;

FIG. 16 is a graph showing an examination result of comparing an area of a circuit configuration for an accelerator of the present invention, a prior-art fixed function accelerator and a typical general-purpose processor;

FIG. 17 is a schematic view showing an examination result of comparing power consumption for an accelerator of the present invention, a prior-art fixed function accelerator, and a typical general-purpose processor;

FIG. 18 is a graph showing an examination result for a performance yield regarding a data path generated in consideration of a function modification after production and a data path used for a prior-art fixed function accelerator;

FIG. 19 is a block diagram showing a circuit configuration of an integrated circuit using an accelerator of the present invention;

FIG. 20 is a block diagram for explaining a patch memory and a patch circuit;

FIG. 21 is a schematic view showing an illustrative arithmetic processing using a first patch and a second patch stored in a patch memory;

FIG. 22 is a block diagram showing a circuit configuration of an accelerator according to another embodiment of the present invention;

FIG. 23 is a schematic view for explaining the performance maximization of a data flow graph and the minimization of a variable retaining period;

FIG. 24 is a schematic view for explaining a case in which an operation node is added;

FIG. 25 is a schematic view for explaining a case in which a new step is created and an operation node is added;

FIG. 26 is a schematic view for explaining a procedure of scheduling;

FIG. 27 is a schematic view for explaining a function unit and a procedure of a register binding;

FIG. 28 is a schematic view showing a circuit configuration of an accelerator having a trace buffer;

FIG. 29 is a schematic view showing an illustrative FSMD; and

FIG. 30 is a table showing successive operations when the FSMD shown in FIG. 29 is executed.

### DETAILED DESCRIPTION OF THE PREFERRED EMBODIMENTS

An embodiment of the present invention will be explained in detail with reference to the accompanying drawings.

### (1) Whole Configuration of Accelerator

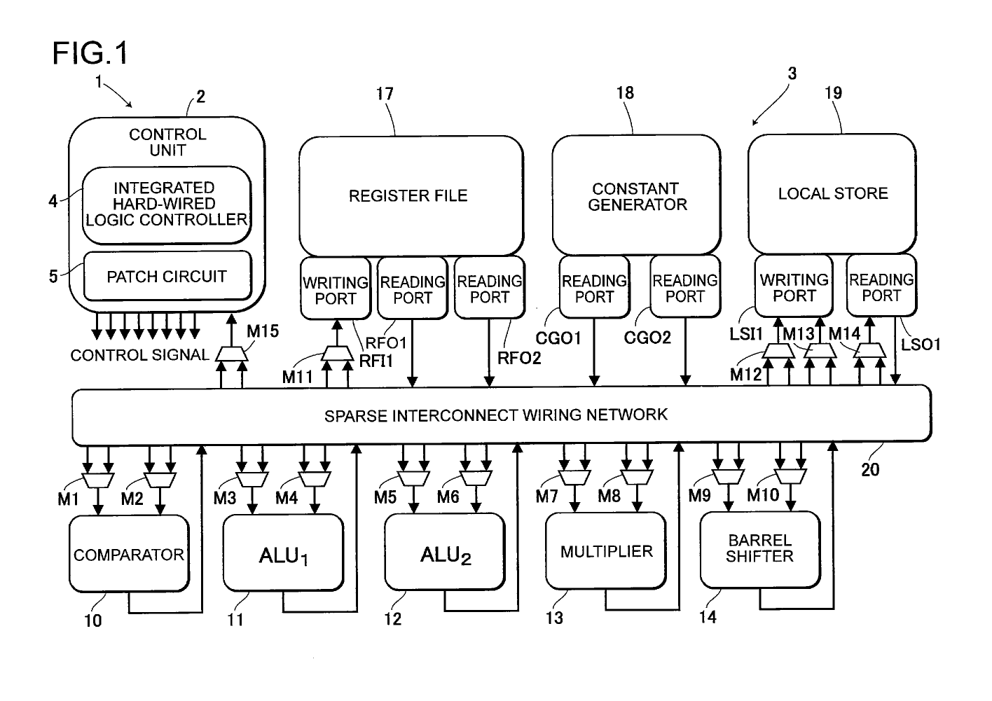

In FIG. 1, reference numeral 1 indicates an accelerator that includes a control unit 2 and a data path 3. The control unit 2 includes an integrated hard-wired logic controller 4, and a predetermined arithmetic processing is executed by the data path 3 in accordance with a control signal from the integrated hard-wired logic controller 4 configured by a hard-wired logic to realize only a predetermined fixed function. In addition to such a configuration, the control unit 2 of the accelerator has a patch circuit 5 that enables the integrated hard-wired logic controller 4 which is configured by a hard-wired logic and does not permit a function modification after production to perform a minor function modification after production by the patch circuit 5. The control unit 2 can receive various data from a sparse interconnect wiring network via a multiplexer M15.

In addition to such a configuration, the data path 3 is provided with, based on a data path synthesis method to be discussed later, a comparator 10, an ALU (Arithmetic Logic Unit)₁ 11, an ALU₂ 12, a multiplier 13, and a barrel shifter 14 (hereinafter, those units are simply referred to as function units), etc., upon prediction of a latent function modification that may occur because of a specification change and a false design after production. Accordingly, the accelerator 1 can maximize the performance yield after a function modification even if a minor function modification is performed on the control unit 2 after production since a function unit to be necessary in order to satisfy the performance constraint by the function modification is selected and provided through the data path synthesis method in advance.

An accelerator 1 with a fixed function which realizes only a certain specific function, such as a motion image playing or a sound processing, has a performance constraint (e.g., a predetermined constraint like an upper limit of an execution time such that a predetermined process must be completed within a certain seconds), and the performance yield is a probability of satisfying a predetermined performance constraint set in advance.

In practice, the data path 3 is provided with, in addition to the function units (the comparator 10, the ALU₁ 11, the ALU₂ 12, the multiplier 13, and the barrel shifter 14), a register file 17, a constant generator 18, and a local store 19 as example memory elements, and those are coupled together via a sparse interconnect wiring network 20. Each function unit is configured to execute equal to or greater than one kind of predetermined arithmetic processing, and to execute each arithmetic processing based on data read from the register file 17 in accordance with a control signal received from the control unit 2.

According to the data path 3, a writing port RFI1 and reading ports RFO1, RFO2 provided for the register file 17, reading ports CGO1 and CGO2 provided for the constant generator 18, and a writing port LSI1 and a reading port LSO1 provided for the local store 19 are regarded as respective function units, accesses to the register file 17, the constant generator 18, and the local store 19 can be handled likewise an arithmetic operation at the time of synthesizing a data path and a function modification after production.

In practice, the comparator 10, the ALU₁ 11, the ALU₂ 12, the multiplier 13, and the barrel shifter 14 have respective inputs coupled to the loosely coupled wiring network 20 via multiplexers M1 to M10, and have respective outputs directly coupled to the sparse interconnect wiring network 20, and respectively select an input signal in accordance with control signals from the multiplexers M1 to M10.

The register file 17 has a plurality of registers (unillustrated), has an input coupled to the sparse interconnect wiring network 20 via the writing port RFI1 and the multiplexer M11, and has an output coupled to the sparse interconnect wiring network 20 via the reading ports RFO1 and RFO2. The register file 17 is configured to store a local variable value in each register, and determines to which register among the plurality of register the register file accesses in accordance with a control signal from the writing port RFI1.

The constant generator 18 is capable of outputting a predetermined constant set in advance, and generating a constant in accordance with control signals to the reading ports CGO1 and CGO2 like the register file 17. The local store 19 is a RAM (Random Access Memory) mainly storing a data arrangement and a global variable value, has an input coupled to the sparse interconnect wiring network 20 via the writing port LSI1 and multiplexers M12 and M13, and has an output coupled to the sparse interconnect wiring network via the reading port LSO1.

The reading port LSO1 is also coupled to a multiplexer M14, and passes data received from the sparse interconnect wiring network 20 to the local store 19. Moreover, the local store 19 is capable of exchanging various data with the exterior. Such a local store 19 has the writing port LSI1 and the reading port LSO1 different from those of the other memory elements, has two signal lines: address and data, and has a writing-enabled control input in the writing port LSI1. The barrel shifter 14 shifts data by a predetermined bit as needed at the time of arithmetic processing, and the comparator 10 compares two processing results, etc., as needed to obtain a comparison result, and both units are used for an arithmetic processing as needed.

The control unit 2 coupled to the sparse interconnect wiring network 20 comprehensively controls the integrated hard-wired logic controller 4 configured by a circuit configuration realized by a hard-wired logic, and various circuits, such as the comparator 10, the ALU₁ 11, the ALU₂ 12, the multiplier 13, the barrel shifter 14, the register file 17, the constant generator 18, and the local store 19, in accordance with a control signal from the patch circuit 5 to execute a predetermined arithmetic processing.

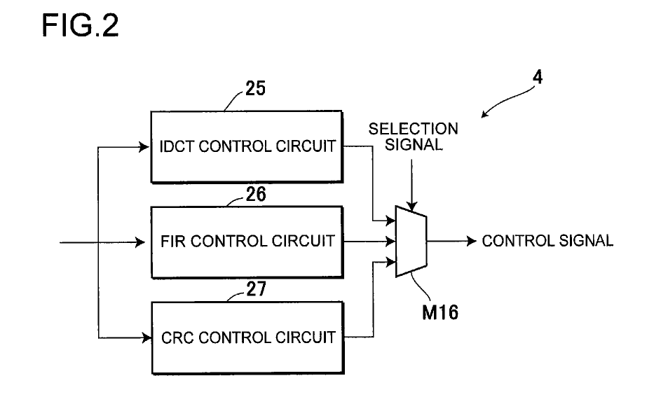

As shown in FIG. 2, according to this embodiment, the integrated hard-wired logic controller 4 includes an IDCT (Inverse Discrete Cosine Transform) control circuit 25, an FIR (Finite Impulse Response) control circuit 26 and a CRC (Cyclic Redundancy Check) control circuit 27, and those IDCT control circuit 25, the FIR control circuit 26, and the CRC control circuit 27 are coupled to a multiplexer M16. The integrated hard-wired logic controller 4 selects any one of the IDCT control circuit 25, the FIR control circuit 26, and the CRC control circuit 27 upon changing of a selection signal to the multiplexer M16, transmits a control signal generated by any one of the selected IDCT control circuit 25, the FIR control circuit 26, and the CRC control circuit 27 to the data path 3, and causes the data path 3 to execute the predetermined arithmetic processing.

As explained above, the integrated hard-wired logic controller 4 can select as needed the IDCT control circuit 25, the FIR control circuit 26, and the CRC control circuit 27 after production, and thus being capable of function change to a circuit configuration that executes any one of an IDCT process, an FIR process, and a CRC process in accordance with, for example, an application change after production. The IDCT control circuit 25, the FIR control circuit 26, and the CRC control circuit 27 are hard-wired logic controllers realizing respective fixed functions and designed through a high-level synthesis based on initially designed specifications, and can be downsized by what corresponds to the absence of an extra circuit configuration like a memory since those circuits are realized by only a hard-wired logic, and can improve the process speed and the power efficiency.

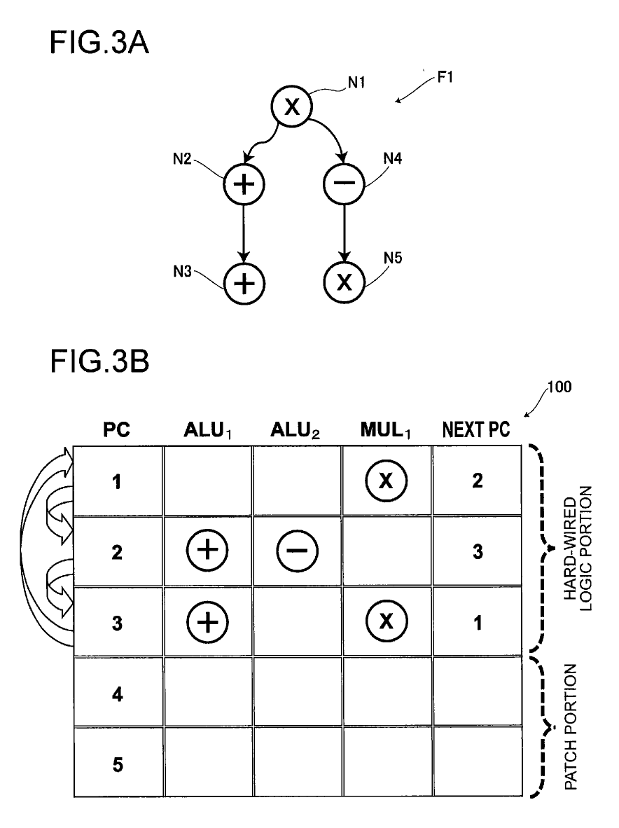

FIG. 3A shows an illustrative data flow graph F1 initially designed for, for example, the IDCT control circuit 25. Such a data flow graph F1 can execute successive arithmetic processing that multiplies predetermined data at an operation node N1, adds the result to another data at an operation node N2, further adds this addition result to the other data at an operation node N3. Separately from this processing, in the data flow graph F1, successive arithmetic processing are also executed which subtracts another data from a result obtained by multiplying predetermined data at an operation node N4, and further multiplies the subtraction result by the other data at an operation node N5. The data flow graph F1 initially designed can be represented by a schedule 100 shown in FIG. 3B, and the successive arithmetic processing of the data flow graph F1 are executed by the ALU₁ 11, the ALU₂ 12, and the multiplier 13 (indicated as “MUL₁” in FIG. 3B) in accordance with control signals generated by the IDCT control circuit 25 based on the schedule 100.

The schedule 100 has the content of a control signal generated by the IDCT control circuit 25 and indicated in the hard-wired logic portion, and program counters 1 to 3 are allocated to the hard-wired logic portion (fields “PC” in FIG. 3B). Each of the program counters 1 to 3 is set with a program counter to be executed next (hereinafter, referred to as a next counter) (fields “next PC” in FIG. 3B). In practice, according to the schedule 100, a state cs1 that is an arithmetic processing instruction for executing a multiplication process is set in the program counter 1, a state cs2 that is an arithmetic processing instruction for executing an addition process and a subtraction process is set in the program counter 2, and a state cs3 that is an arithmetic processing instruction for executing an addition process and a multiplication process is set in the program counter 3.

Moreover, according to the schedule 100, for example, a next counter that is the program counter 2 is indicated to the program counter 1, another next counter that is the program counter 3 is indicated to the program counter 2, and the other next counter that is the program counter 1 is indicated to the program counter 3. Arithmetic processing is repeated in the order of the program counter 1, the program counter 2, the program counter 3, and the program counter 1 as a state transition in accordance with a next counter.

When such a schedule 100 is executed, as shown in FIG. 2, the integrated hard-wired logic controller 4 selects the IDCT control circuit 25 that executes the schedule 100 upon transmission of a predetermined selection signal to the multiplexer M16 (see FIG. 2), and the IDCT control circuit 25 transmits control signals to the data path 3 in the order of a control signal indicating the content of the program counter 1, a control signal indicating the content of the program counter 2, and a control signal indicating the content of the program counter 3, in accordance with the next counters.

When receiving the control signal from the IDCT control circuit 25 via the sparse interconnect wiring network 20, the multiplexers M12 and M13, and the writing port LSI1, sequentially, the local store 19 receives predetermined data from an external memory based on the control signal, and passes this data to the register file 17 via the reading port LSO1, the sparse interconnect wiring network 20, the multiplexer M11 and the writing port RFI1, sequentially.

The register file 17 writes such data in any one of the registers, and transmits the data to the multiplier 13 via the reading port RFO1 in accordance with the state cs1 based on the control signal indicating the content of the program counter 1. When receiving the data from the register file 17 or other data via the multiplexers M7 and M8, the multiplier 13 executes a multiplication process on such data, and transmits an obtained multiplication result to the register file 17. The register file 17 receives the multiplication result via the multiplexer M11 and the writing port RFI1, and writes the multiplication result in a predetermined register.

Next, the data path 3 receives the control signal indicating the content of the program counter 2 in accordance with the next counter from the IDCT control circuit 25, reads the multiplication result from the register file 17 in accordance with the control signal, and transmits the read multiplication result to respective ALU₁ 11 and ALU₂ 12 via the reading port RFO1. Accordingly, the ALU₁ 11 receives the multiplication result and other data via the multiplexers M3 and M4, executes an addition process on the multiplication result in accordance with the state cs2 of the program counter 2, and transmits the obtained addition result to the register file 17.

While at the same time, the ALU₂ 12 receives the multiplication result and other data via the multiplexers M5 and M6, executes a subtraction process on the multiplication result in accordance with the state cs2 of the program counter 2, and transmits the obtained subtraction result to the register file 17. The register file 17 receives the addition result from the ALU₁ 11 and the subtraction result from the ALU₂, respectively, 12 via the multiplexer M11 and the writing port RFI1, sequentially, and writes those results in predetermined registers.

Next, the data path 3 receives the control signal indicating the content of the program counter 3 in accordance with the next counter from the IDCT control circuit 25, reads the addition result from the register file 17 via the reading port RFO1 in accordance with the control signal, and transmits the read addition result to the ALU₁ 11. Simultaneously, the data path reads the subtraction result from the register file 17 via the reading port RFO2, and transmits the read subtraction result to the multiplier 13.

Accordingly, the ALU₁ 11 receives the addition result and other data via the multiplexers M3 and M4, executes the addition process in accordance with the state cs3 indicated by the program counter 3, and transmits the obtained new addition result to the register file 17. Simultaneously, the multiplier 13 receives the subtraction result and other data via the multiplexers M7 and M8, executes the multiplication process in accordance with the state cs3 indicated by the program counter 3, and transmits the obtained multiplication result to the register file 17. The register file 17 receives the new addition result obtained by the ALU₁ 11 and the multiplication result obtained by the multiplier 13 via the multiplexer M11 and the writing port RFI1, respectively, and writes those results in predetermined registers.

Next, the register file 17 receives again the control signal indicating the content of the program counter 1 in accordance with the next counter of the program counter 3, receives new data from the exterior via, for example, the local store 19 in accordance with the state cs1 based on the received control signal, writes the received data in a predetermined register, and transmits such data to the multiplier 13. Hence, the above-explained successive arithmetic processing is executed again. The accelerator 1 successively transmits the control signals generated by the IDCT control circuit 25 to the data path 3 in this fashion, and executes the successive arithmetic processing in accordance with the schedule 100 shown in FIG. 3B.

According to the above-explained embodiment, the explanation was given of a case in which the arithmetic processing according to the schedule 100 is executed by the data path 3 based on the control signals from the IDCT control circuit 25 configured by the hard-wired logic. Likewise, according to the present invention, for the FIR control circuit 26 and the CRC control circuit 27 configured by the hard-wired logic, based on the control signal from the FIR control circuit 26 or the CRC control circuit 27, the successive arithmetic processing according to each schedule is executed by the data path 3.

In addition to the above-explained configuration, in the accelerator 1, the IDCT control circuit 25, the FIR control circuit 26, and the CRC control circuit 27 in the integrated hard-wired logic controller 4 are configured by the hard-wired logic to realize respective fixed functions, but a minor function modification is enabled by the patch circuit 5 to be discussed later after production. Next, an explanation will be given of a function modification by the patch circuit 5 after production.

### (2) Outline of Function Modification to Accelerator after Production

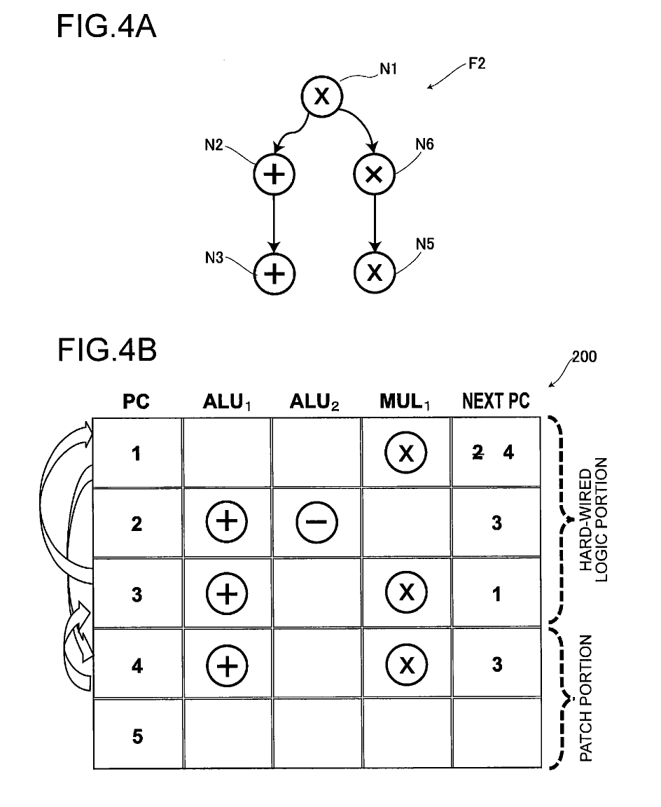

As an example case, the explanation will be given of a case in which the operation node N4 for a subtraction process in the data flow graph F1 initially designed and shown in FIG. 3A is subjected to a function modification to an operation node N6 for a multiplication process of a data flow graph F2 shown in FIG. 4A. The data flow graph F2 having undergone such a function modification can be represented as a schedule 200 shown in FIG. 4B, and the successive arithmetic processing of the data flow graph F2 are executed by the ALU₁ 11, the ALU₂ 12, and the multiplier 13, etc., based on control signals generated by the integrated hard-wired logic controller 4 and the patch circuit 5 in accordance with the result of the schedule 200.

In this case, the schedule 200 having undergone the function modification has the content of the control signal generated by the patch circuit 5 and indicated by a patch portion, and an additional program counter 4 or 5 is allocated to the patch portion (fields “PC” in FIG. 3B), and a state cs4 that is a modified arithmetic processing instruction for executing an addition process and a multiplication process is set as a patch to the additional program counter 4. Moreover, according to the schedule 200, the program counter 2 set as the next counter of the program counter 1 is changed to the additional program counter 4, and the program counter 3 is set as the next counter of the additional program counter 4, and the arithmetic processing is repeated in the order of the program counter 1, the additional program counter 4, the program counter 3, and the program counter 1 as a state transition in accordance with the next counters.

That is, according to the schedule 200 having undergone the function modification, the next counter of the program counter 1 is changed to the additional program counter 4. Hence, after the state cs1 indicated by the program counter 1 is executed, the state transitions to not the program counter 2 but the newly set additional program counter 4, and the state cs4 set in the additional program counter 4 is executed. Moreover, according to the schedule 200, after the state transitions to the program counter 3 like the case before the function modification in accordance with the next counter of the additional program counter 4 and the state cs3 is executed, the state returns again to the program counter 1 in accordance with the next counter of the program counter 3, and the successive arithmetic processing having undergone the above-explained function modification is repeated.

According to the schedule 200 having undergone the function modification, as explained above, the state can transition to the additional program counter 4 that is the state cs4 for executing the addition process and the multiplication process following the program counter 1 for executing the multiplication process, and thus the function modification to the accelerator 1 is enabled.

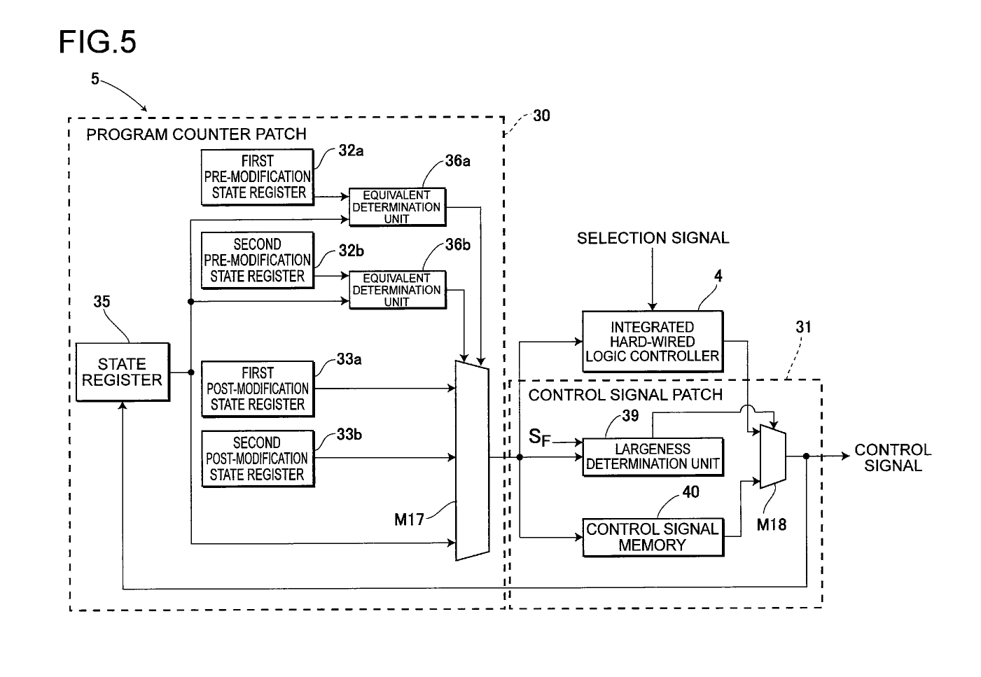

The patch circuit 5 that enables the above-explained function modification includes, as shown in FIG. 5, a program counter patch 30, and a control signal patch 31. The program counter patch 30 enables modification of, for example, the program counter 2 which is originally executed following the program counter 1 to the new additional program counter 4.

In this case, the program counter patch 30 is provided with a first pre-modification state register 32a and a second pre-modification state register 32b in accordance with the number of program counters to be modified (in this embodiment, two). A first post-modification state register 33a is provided in association with the first pre-modification state register 32a, and a second post-modification state register 33b is provided in association with the second pre-modification state register 32b.

According to the above-explained embodiment, the explanation was given of a case in which the two registers: the first pre-modification state register 32a and the second pre-modification state register 32b are provided, but the present invention is not limited to this case. A further plurality of pre-modification state registers, such as a third pre-modification state register and a fourth pre-modification state register, may be provided in accordance with the number of program counters to be modified.

When the schedule 100 shown in FIG. 3B is subjected to a function modification to the schedule 200 shown in FIG. 4B, the program counter 2 is stored in only the first pre-modification state register 32a between the first and second pre-modification state registers 32a and 32b. Moreover, the additional program counter 4 is stored in the first post-modification state register 33a associated with the first pre-modification state register 32a.

In practice, when the program counter 1 is given to the state register 35, the program counter patch 30 transmits the given program counter as counter data to equivalence determination units 36a and 36b and the multiplexer M17, respectively. The equivalence determination units 36a and 36b determine whether or not the program counter 1 consistent with the counter data is stored in respectively corresponding first pre-modification state register 32a and second pre-modification state register 32b. According to this embodiment, the equivalence determination units 36a and 36b respectively generate inconsistency signals each indicating that the program counter 1 consistent with the counter data is not stored in the first pre-modification state register 32a or the second pre-modification state register 32b since respectively corresponding first pre-modification state register and second pre-modification state register store no program counter 1, and transmit such signals to the multiplexer M17.

Accordingly, the multiplexer M17 directly transmits the counter data indicating the program counter 1 and received from the state register 35 to the integrated hard-wired logic controller 4 and the control signal patch 31, respectively. The control signal patch 31 includes a largeness determination unit 38 and a control signal memory 40, and receives the counter data from the program counter patch 30 through the largeness determination unit 39 and the control signal memory 40.

The largeness determination unit 39 is set with a maximum value S_{F} (e.g., in FIG. 3B, a maximum value “3” indicating the maximum value of the program counters 1 to 3) of the program counter to be the hard-wired logic portion, and determines the largeness relation between the value of the counter data received from the program counter patch 30 and the maximum value S_{F} of the program counter.

When the counter data received from the program counter patch 30 is within the maximum value S_{F}, the largeness determination unit 39 transmits the control signal generated by the integrated hard-wired logic controller 4 to the data path 3 via a multiplexer M18. Conversely, when the counter data received from the program counter patch 30 exceeds the maximum value S_{F}, the largeness determination unit 39 transmits the control signal generated by the control signal memory 40 to the data path 3 via the multiplexer M18 instead of the control signal generated by the integrated hard-wired logic controller 4.

When, for example, the IDCT control circuit 25 is selected based on the selection signal in the integrated hard-wired logic controller 4, if the largeness determination unit 39 receives the counter data indicating the program counter 1, since the value of the counter data (the program counter 1) is within the maximum value S_{F} “3”, the largeness determination unit transmits the control signal indicating the content of the program counter 1 transmitted from the IDCT control circuit 25 to the data path 3 and the state register 35, respectively, via the multiplexer M18. Accordingly, the data path 3 can execute the arithmetic processing in accordance with the state cs1 of the program counter 1 based on the control signal.

Conversely, the state register 35 extracts, as counter data, the program counter 2 that is the next counter set for the program counter 1 from the control signal, and transmits the extracted counter data to the equivalence determination units 36a, 36b and the multiplexer M17. In this case, the equivalence determination unit 36a coupled to the first pre-modification state register 32a determines that the program counter 2 stored in the first pre-modification state register 32a is consistent with the counter data received from the state register 35, and transmits, as a counter consistency signal, the determination result to the multiplexer M17.

Accordingly, the multiplexer M17 selects, as changed counter data, the additional program counter 4 stored in the first post-modification state register 33a in association with the first pre-modification state register 32a, and transmits the changed counter data to the largeness determination unit 39, the control signal patch 31 and the integrated hard-wired logic controller 4 instead of the counter data received from the state register 35.

The control signal memory 40 of the control signal patch 31 has a patch which includes the state cs4 that is a content of the program counter 2 having undergone a design modification for executing an addition process and a multiplication process, and the program counter 3 set as the next counter and which is stored in the additional program counter 4. Data for a function modification like the state cs4, etc., stored in the control signal memory 40 is generated by another computer in accordance with “(3) Patch Compilation Method based on Integer Linear Programming” to be discussed later depending on the content of the function modification performed on the accelerator 1 after production, and stored in the additional program counter 4 of the control signal memory 40.

When receiving the changed counter data indicating the additional program counter 4 from the program counter patch 30, the largeness determination unit 39 transmits, as a control signal, the content of the additional program counter 4 read from the control signal memory 40 to the data path 3 and the state register 35, respectively, via the multiplexer M18 instead of the control signal from the integrated hard-wired logic controller 4 since the value of the changed counter data (the additional program counter 4) exceeds the maximum value S_{F} “3”.

Accordingly, the data path 3 executes the arithmetic processing in accordance with the state cs4 set for the additional program counter 4 based on the control signal. The patch circuit 5 invalidates the program counter 2, selects the additional program counter 4 instead of the program counter 2, and causes the data path 3 to execute the arithmetic processing having undergone the function modification in accordance with the state cs4 in this fashion.

Conversely, the state register 35 extracts, as counter data, the program counter 3 that is the next counter set for the additional program counter 4 from the control signal upon reception of the control signal from the control signal patch 31, and transmits the extracted counter data to the equivalence determination units 36a, 36b and the multiplexer M17, respectively. Since the program counter 3 consistent with the counter data is not stored in the first pre-modification state register 32a or the second pre-modification state register 32b, the equivalence determination units 36a and 36b generate inconsistency signals indicating to that effect, and transmit the generated signals to the multiplexer M17.

Accordingly, the multiplexer M17 directly transmits the counter data indicating the program counter 3 and received from the state register 35 to the largeness determination unit 39, the integrated hard-wired logic controller 4, and the control signal patch 31. The largeness determination unit 39 transmits the control signal indicating the content of the program counter 3 and transmitted from the IDCT control circuit 25 to the data path 3 and the state register 35, respectively, via the multiplexer M18 upon reception of the counter data indicating the program counter 3 since the value of the counter data (the program counter 3) is within the maximum value S_{F} “3”. Hence, the data path 3 can execute the arithmetic processing in accordance with the state cs3 of the program counter 3 based on the control signal.

Conversely, the state register 35 extracts, as counter data, the program counter 1 that is the next counter set for the program counter 3 from the control signal, and transmits the extracted counter data to the equivalence determination units 36a, 36b and the multiplexer M17. Since the program counter 1 consistent with the counter data is not stored in both first pre-modification state register 32a and the second pre-modification state register 32b, the corresponding equivalence determination units 36a and 36b generate counter inconsistency signals indicating to that effect, and transmit the generated signals to the multiplexer M17.

Accordingly, the multiplexer M17 directly transmits the counter data indicating the program counter 1 and received from the state register 35 to the largeness determination unit 39, the integrated hard-wired logic controller 4, and the control signal patch 31, respectively. Since the value of the counter data (the program counter 1) is within the maximum value S_{F} “3”, like the above-explained case, the largeness determination unit 39 transmits the control signal indicating the content of the program counter 1 and transmitted from the IDCT control circuit 25 to the data path 3 and the state register 35, respectively, via the multiplexer M18 again. Accordingly, the data path 3 can execute again the arithmetic processing in accordance with the state cs1 of the program counter 1 based on the control signal.

The control unit 2 repeats the successive arithmetic processing in the order of the program counter 1, the additional program counter 4, the program counter 3, and the program counter 1, causes the data path 3 to execute the state cs4 of the additional program counter 4 instead of the state cs2 of the program counter 2, thereby performing a function modification in this fashion.

According to the patch circuit 5, in the program counter patch 30, the second pre-modification state register 32b may further store, for example, the program counter 3 and the second post-modification state register 33b may newly store an additional program counter 5.

In this case, the state register 35 extracts, as counter data, the program counter 3 that is the next counter set for the additional program counter 4 from the control signal, and transmits the extracted counter data to the equivalence determination units 36a, 36b and the multiplexer M17, respectively. Since the program counter 3 stored in the second pre-modification state register 32b is consistent with the counter data received from the state register 35, the equivalence determination unit 36b coupled to the second pre-modification state register 32b transmits a counter consistency signal that is the determination result to the multiplexer M17.

Accordingly, the multiplexer M17 selects, as changed counter data, the additional program counter 5 stored in the second post-modification state register 33b associated with the second pre-modification state register 32b, and transmits the changed counter data to the largeness determination unit 39, the control signal path 31, and the integrated hard-wired logic controller 4 instead of the counter data received from the state register 35.

The control signal memory 40 of the control signal patch 31 has a patch which includes a state cs5 for executing a predetermined arithmetic processing having undergone a design change of the program counter 3, and the program counter 1 set as the next counter and which is stored in the additional program counter 5. Since the value of the changed counter data (the additional program counter 5) exceeds the maximum value S_{F} “3”, the largeness determination unit 39 transmits, as the control signal, the content of the additional program counter 5 read from the control signal memory 40 to the data path 3 and the state register 35, respectively, via the multiplexer M18 instead of the control signal from the integrated hard-wired logic controller 4 upon reception of the changed counter data indicating the additional program counter 5 from the program counter patch 30.

Accordingly, the data path 3 can execute the arithmetic processing in accordance with the state cs5 set for the additional program counter 5 based on the control signal. The patch circuit 5 further invalidates the program counter 3, selects the additional program counter 5 instead of the program counter 3, and causes the data path 3 to execute the arithmetic processing having undergone the function modification in accordance with the state cs5 in this fashion. The control unit 2 enables the function modification so that the process is repeated in the order of the program counter 1, the additional program counter 4, the additional program counter 5, and the program counter 1.

### (3) Patch Compilation Method Based on Integer Linear Programming

Next, an explanation will be given of a patch compilation method of compiling the content stored in the control signal memory 40 based on a difference between an initial design description and a design description having undergone the function modification when the function modification is performed on the control unit 2 after the production. In this case, a designer obtains a difference between the data flow graph F1 (see FIG. 3A) initially designed and the data flow graph F2 (see FIG. 4A) having undergone the function modification, and a scheme of formulating the compiling of the patch based on this difference by an integer linear programming, and of obtaining an exact solution through the integer linear programming is applied. The formulation of the integer linear programming and the set contents of the additional program counter 4 and the additional program counter 5 in the control signal memory 40 that are obtained through the integer linear programming are accomplished using an unillustrated and separate computer.

The design description before and after the modification can be represented by a graph G=(0, E) that combines the data flow graphs before and after the modification. 0 indicates a set of operation nodes, which can be a sum set including a set 0_{f} of unmodified operation nodes, a set 0ᵣ of eliminated operation nodes, and a set 0ₘ of newly added operation nodes, and can be expressed as 0=0_{f}∪0ₘ∪0ᵣ. That is, the set of operation nodes before the modification is 0_{f}∪0ᵣ, and the set of operation nodes after the modification is 0_{f} U 0ₘ. A predetermined operation node in the set 0ₘ={o1, o2, . . . } of the newly added operation nodes will be indicated as oi. Each data dependency side e εE indicates the data dependency relation between respective operation nodes. That is, the data dependency side means a data edge interconnecting the operation nodes.

A data path includes a set F={f1, f2, . . . } of function units (hereinafter, a predetermined function unit in such a set will be indicated as fj), and a set P={p1, p2, . . . } of register file ports (the reading ports RFO1, RFO2 and the writing port RFI1 provided for the register file 17 in FIG. 1) (hereinafter, a predetermined register file port will be indicated as pq). A control step S={s1, s2, . . . } (hereinafter, predetermined control step will be indicated as sk) corresponds to each state cs1, cs2, etc., of the control circuit (e.g., the IDCT control circuit 25 among the IDCT control circuit 25, the FIR control circuit 26, and the CRC control circuit 27), and the control step for executing each operation oε0_{f}∪0ᵣ before the modification is defined as S₀(o), and the function unit used in that operation is defined as F₀(o). Moreover, the maximum value of the total number of control steps modifiable is defined as Mₘₐₓ. The maximum value Mₘₐₓ of the total number of modifiable control steps corresponds to the number of words of the control signal memory 40.

In the patch compilation method, it is necessary to set the control step S(o) of each added operation node oε0ₘ, and the function unit F(o) used for the operation at each added operation node oε0ₘ. Hence, an explanation will be given of a scheme of expressing the control step S(o) of each added operation node oε0ₘ, and the function unit F(o) used for the operation at each added operation node oε0ₘ as a constraint formula with integer variables and obtaining those trough the integer linear programming.

In this case, it is presumed that the operation before the modification is already scheduled in the control step. Next, an empty control step is inserted between respective control steps. The operation scheduled in the empty control step is implemented in the control signal memory 40 of the patch circuit 5. The number of empty control steps inserted between respective control steps is the smaller one of the number of words of the control signal memory 40 or the number of control steps necessary when it is scheduled most negatively. The case when it is scheduled most negatively means a case in which each additional operation node is scheduled in different control steps, and indicates the logical upper limit of the number of necessary control steps.

Next, an explanation will be given of variables used in the constraint formula. All variables explained below are binary variables. For example, B_{i,j,k} is a variable that becomes 1 in a control step sk when the operation node of uses the function unit fj (where i, j, and k indicate respective predetermined integers). Moreover, G_{j,k,q,t} is a variable that becomes 1 in the control step sk when the t-th input/output signal line of the function unit fj uses the register file port pq. Furthermore, Mk is a variable that becomes 1 when the control step sk contains a change. The constraint formula can be classified into the following seven kinds.

(3-1) First Constraint (Constraint for Use of Operation)

Each additional operation node of in the data flow graph must be scheduled just one time in the predetermined control step sk. When it is expressed as a constraint formula, the following formula can be obtained.

$$\begin{matrix}[ Formula 1 ] & \\ {\sum }_{j , k} {B}_{i , j , k} = 1 ∀ i & ( 1 )\end{matrix}$$

(3-2) Second Constraint (Resource Constraint)

The function unit fj can be used just one time in each control step sk. When it is expressed as a constraint formula, the following formula can be obtained.

$$\begin{matrix}[ Formula 2 ] & \\ {\sum }_{i} {B}_{i , j , k} \leq 1 \\ ∀ j , k & ( 2 )\end{matrix}$$

(3-3) Third Constraint (Data Dependency Constraint)

Regarding the data dependency side indicating the relationship between an operation node of and an operation node ox in the data flow graph, the operation at the start point must be scheduled prior to the operation at the end point. When it is expressed as a constraint formula, the following formula can be obtained. The first item in the left of the following formula 3 corresponds to the control step for the operation at the start point, and the right of such a formula corresponds to the control step for the operation at the end point.

$$\begin{matrix}[ Formula 3 ] & \\ {\sum }_{k} k ( {\sum }_{j} {B}_{l , j , k} ) + 1 \leq {\sum }_{k} k ( {\sum }_{j} {B}_{x , j , k} ) \\ ∀ ( {o}_{l} , {o}_{x} ) ∈ E & ( 3 )\end{matrix}$$

(3-4) Fourth Constraint (Modified Control Step Constraint)

A variable Mₖ becomes 1 when the control step sk is modified. When it is expressed as a constraint formula, the following formula can be obtained.

[Formula 4]

B_{i,j,k}≦Mₖ≦1∀i,j,k (4)

(3-5) Fifth Constraint (Eliminated Operation Constraint)

The control step having a scheduled operation node oyε0ᵣ to be eliminated becomes a modified control step unconditionally, and M_{step(oy)} that is a variable becomes 1. When it is expressed as a constraint formula, the following formula can be obtained.

[Formula 5]

Mₛₜₑₚ₍ₒ_{_{y}}₎=1∀o_{y}ε0ᵣ (5)

(3-6) Sixth Constraint (Maximum Modified Control Step Number Constraint)

The upper limit of the maximum value Mₘₐₓ of the modifiable control steps is determined based on the number of words of the control signal memory 40 in the path circuit. When it is expressed as a constraint formula, the following formula can be obtained.

$$\begin{matrix}[ Formula 6 ] & \\ {\sum }_{k} {M}_{k} \leq {M}_{ma x} & ( 6 )\end{matrix}$$

(3-7) Seventh Constraint (Register Port Constraint)

No chaining is considered herein in order to simplify the explanation. That is, each function unit reads predetermined data from the register file 17, and stores an operation result in the register file 17. Hence, it is necessary that both input/output of each function unit be coupled to register file ports (in FIG. 1, the reading ports RFO1, RFO2 and the writing port RFI1 provided for the register file 17). When it is expressed as a constraint formula, the following formula can be obtained.

$$\begin{matrix}[ Formula 7 ] & \\ {\sum }_{j , t} {G}_{j , k , q , t} \leq 1 \\ ∀ k , q & ( 7 )\end{matrix}$$

Allocation of respective variables to the registers is obtained by applying a scheme like “P. Brisk, F. Dabiri, R. Jafari, and M. Sarrafzadeh, “Optimal register sharing for high-level synthesis of SSA form programs”, IEEE Trans. Computer-Aided Design, vol. 25, no. 5, pp. 772 to 779, May 2006”, after an integer linear programming problem is solved.

By solving the constraint formulae of the above-explained first to seventh constraints through the integer linear programming, the control step of each operation and the function unit to be used for such an operation are obtained. When no solution is settled even if the constraint formulae of the above-explained first to seventh constraints are solved by the integer linear programming, it means that a function modification is not enabled based on the number of words of the control signal memory 40 provided in the patch circuit 5.

### (4) Data Path Synthesis Method

(4-1) Outline of Data Path Synthesis Method

The data path 3 of the accelerator 1 of the present invention has the function units selected in consideration of, in advance, a latent function modification that may occur after production based on a data path synthesis method to be discussed later at the time of designing to maximize the performance yield after the function modification. Hereinafter, an explanation will be given of the data path synthesis method according to the present invention.

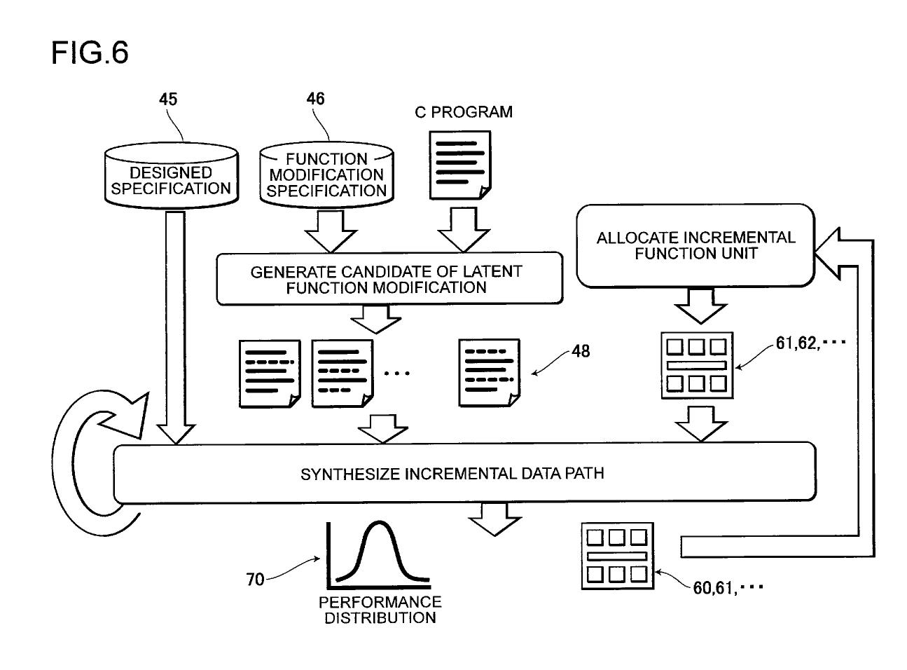

FIG. 6 is a schematic view showing successive flows of the data path synthesis method according to the present invention. According to this data path synthesis method, at the time of designing the accelerator 1, first, the minimum structure of the function units necessary for operating the initial design description is allocated through a general high-level synthesis based on an initially designed specification 45. In practice, like the general high-level synthesis, a high-level design description written in the C language, etc., and design constraints are input into a computer to generate an RTL (Register Transfer Level) description that is a description on a hardware level from a behavioral description describing the behavior of an LSI, and a data path corresponding to the initially designed specification is obtained.

Next, a virtual change, such as newly adding a predetermined operation node to a data flow graph representing the initially designed specification or changing the link between the operation nodes in such a data flow graph, is performed at random, and a modified data flow graph with, for example, several hundred patterns that are the contents of the data flow graph changed in consideration of a function modification is generated as a diverse set. The diverse set means a set of different events, and is a probability space where each event has a probability. Each event is referred to as a variant, and the probability of each event is used for a calculation of the performance yield.

According to the design change by high-level designing, a part of the initial design description is changed. In general, at the stage of initial designing, it is unknown what function modification will be made in practice after production, and patterns of design change available at the initial designing are tremendous, and it is difficult in practice to obtain in full detail. Hence, according to the present invention, a modified pattern by a function modification is modeled in advance, candidates of latent function modification are generated by random sampling from a function modification specification 46 having the number of modifications set in advance, modified C programs 48 each of which is a C program having undergone a design change are obtained, and a set of design descriptions after the function modification and expressed by the modified C programs 48 is taken as the diverse set.

An operation node is added or a data edge is changed to perform design change with reference to the data flow graph initially designed, and the data flow graph initially designed is modified to model latent function modification. Two modified models: a first modified model that inserts a predetermined operation node on the data edge; and a second modified model that deletes or adds a data edge are considered as the function modification specification 46, and those first and second modified models are selected at random by predetermined times to modify the initially designed specification 45. The first model corresponds to a design change that adds a new operation in a given formula in a high-level description, and the second model corresponds to a design change that exchanges two variable references in the high-level description.

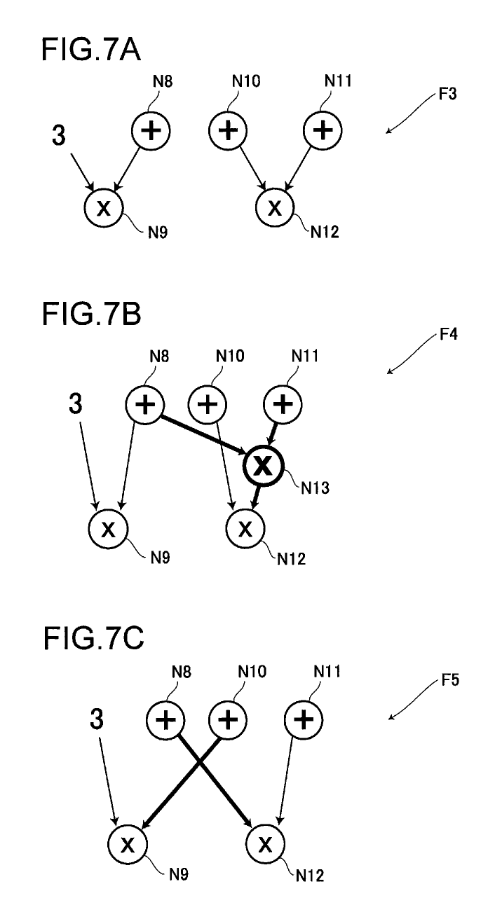

For example, FIG. 7A shows a data flow graph F3 generated based on the initially designed specification, and represents successive multiplication processes which add predetermined data at an operation node N8 and multiply the result thereof by data from “3” at an operation node N9 (note that “3” indicates a predetermined operation node). Moreover, in addition to such successive multiplication processes, the data flow graph F3 also represents successive arithmetic processing which add predetermined data at an operation node N10, add another data at an operation node N11, and multiply those addition results at an operation node N12. Hereinafter, an explanation will be given of the above-explained first and second modified models using such data flow graph F3.

As shown in FIG. 7B, according to a modified data flow graph F4 that represents a virtual arithmetic processing indicating an illustrative function modification on the data flow graph F3, for example, a data edge indicating the data dependency relation between an operation node N11 of an addition process and an operation node N12 of a multiplication process is selected at random as a changed data edge. Moreover, according to this embodiment, for example, among the operation node of an addition process, the operation node of a subtraction process, and the operation node of a multiplication process, an operation node N13 of the multiplication process is selected at random, and the operation node N13 is newly added to a changed data edge, and a new data edge is generated between the operation node N8 of another addition process selected at random and the operation node N13.

According to the modified data flow graph F4 indicating a virtual arithmetic processing, two changes: a change of newly adding the operation node N13 of the multiplication process; and a change of generating a data edge interconnecting the operation node N8 of another addition process with the operation node N13 of the multiplication process are selected and executed at random. When the new operation node has a plurality of inputs, an appropriate number of operation nodes are selected at random as inputs.

As another example of the function modification on the data flow graph F3, as shown in FIG. 7C, according to a modified data flow graph F5, a data edge indicating the data dependency relation between the operation node N8 of the addition process and the operation node N9 of the multiplication process is selected at random (see FIG. 7A), such an data edge is eliminated, and a new data edge interconnecting the operation node N8 of the addition process with the operation node N12 of another multiplication process selected at random is generated.

According to the modified data flow graph F5 indicating a virtual arithmetic processing, a data edge indicating the data dependency relation between the operation node N10 of another addition process and the operation node N12 of the multiplication process (see FIG. 7A) is selected at random, such a data edge is eliminated, and a new data edge that interconnects the operation node N10 of the addition process with the operation node N9 of another multiplication process selected at random is generated.

As explained above, according to the modified data flow graph F5, two changes: eliminating the data edge between the operation node N8 of the predetermined addition process and the operation node N9 of the multiplication process and generating the new data edge that interconnects the operation node N8 with the operation node N12 of the multiplication process; and eliminating the data edge between the operation node N10 of another addition process and the operation node N12 of the multiplication process and generating the new data edge that interconnects the operation node N10 with the operation node N9 of the multiplication process are selected and executed at random.

According to this embodiment, the function modification designing generated from the initial designing by a modification has a scale of function modification from the initial designing set by the number of modifications, and the number of modifications is specified in advance so that the function modification is performed within, for example, several % from the initial designing. Moreover, each modification, such as addition of a new operation node or addition of a data edge, occurs at the same probability.

In practice, according to the data path synthesis method, first, either one of the first and second modified models is selected at random with respect to the data flow graph F3 generated in accordance with the initially designed specification 45 to generate a new modified data flow graph F4. Next, as shown in FIG. 6, incremental scheduling-binding synthesis to be discussed later is repeatedly performed on the modified data flow graph F4, and interconnections each between respective function units are added as needed so that the modified data flow graph F4 can be executed through the initial data path.

Thereafter, it is determined whether or not a data path 60 having the interconnection between the function units newly generated as explained above satisfies the preset performance constraint. When such a performance constraint is not satisfied, an estimated function unit necessary to satisfy the performance constraint is specified, this function unit is newly allocated to the initial data path (“allocate incremental function unit” in FIG. 6), and a configuration of a new data path (hereinafter, referred to as a function modification tolerant data path) 61 is set.

Next, either one of the first and second modified models are selected again at random, and a new modified data flow graph F5 is generated again from the data flow graph F3 generated in accordance with the initial designing. Subsequently, the incremental scheduling-binding synthesis to be discussed later is repeatedly performed on the new modified data flow graph F5, and interconnections between respective function units are added as needed so that the function modification tolerant data path 61 generated beforehand can execute the modified data flow graph F5.

Thereafter, it is determined whether or not the function modification tolerant data path 61 having the interconnections between the function units newly generated as explained above satisfies the preset performance constraint. When the performance constraint is not satisfied, an estimated function unit necessary to satisfy the performance constraint is specified, and this function unit is further allocated to the function modification tolerant data path 61 (“allocate incremental function unit” in FIG. 6), thereby setting again a configuration of a new function modification tolerant data path 62.

As explained above, according to the data path synthesis method, the design change is performed by a preset number, and new function units are successively added as needed so that the predetermined performance constraint is satisfied for each design change, and eventually, the data path 3 with all function units added as needed design change by design change is generated, and thus the accelerator 1 of the present invention is produced which has the data path 3 provided with the control unit 2. According to such a data path synthesis method, since it is possible to provide a necessary function unit in consideration of a latent function modification in advance that may occur after the production, when the function modification is performed by the patch circuit 5, a technical issue such that the function modification cannot be carried out within the range where the performance constraint is satisfied due to, for example, the lack of the multiplier 13 can be prevented, and thus the performance yield after the function modification is maximized.

A graph 70 indicating the performance distribution in FIG. 6 indicates that the processing capability becomes better as going to the left on the horizontal axis, and the vertical axis indicates the number of data paths having respective processing capabilities. Accordingly, such a graph can be a rough standard how many data paths satisfying the performance constraint are present in the data paths having undergone the design change.

(4-2) Incremental Scheduling-Binding Synthesis

Next, an explanation will be given of the incremental scheduling-binding synthesis. Symbols used in the explanation for “(4-2) Incremental Scheduling-Binding Synthesis” are separately defined from the symbols used in the explanation for “(3) Patch Compilation Method based on Integer Linear Programming”, and even the same symbol has a different meaning.

In this case, first, input high-level design descriptions are analyzed to establish a control data flow graph (CDFG). It is presumed that respective formulae expressed in the control data flow graph are in a static single assignment (SSA) form. The control data flow graph includes a control flow graph (CFG) G_{C}=(V_{C}, E_{C}), and a data flow graph (DFG) G_{D}=(V_{D}, E_{D}). The control flow graph includes a set V_{C} of control nodes representing a basic block, and a set E_{C} of control edges representing respective control flows of control nodes. The basic block means successive operation having not control change.

The data flow graph includes a set V_{D} of operation nodes and a set E_{D} of data edges representing respective data dependency relations between operation nodes. A schedule S:V_{D}→U is defined as a map from the set of the operation nodes to the set of control steps. A data path A=(F, I) includes a set F of the function units and a set I of wirings between the function units. An allocation of the function unit B:V_{D}→F is defined as a map from the set of operation nodes to the set F of the function units. A set T⊂V_{D} of operation nodes subjected to the incremental scheduling-binding synthesis is referred to as a target node. It is presumed that the schedule of a remaining operation node (V_{D}−T) and the allocation of the function unit are already given.

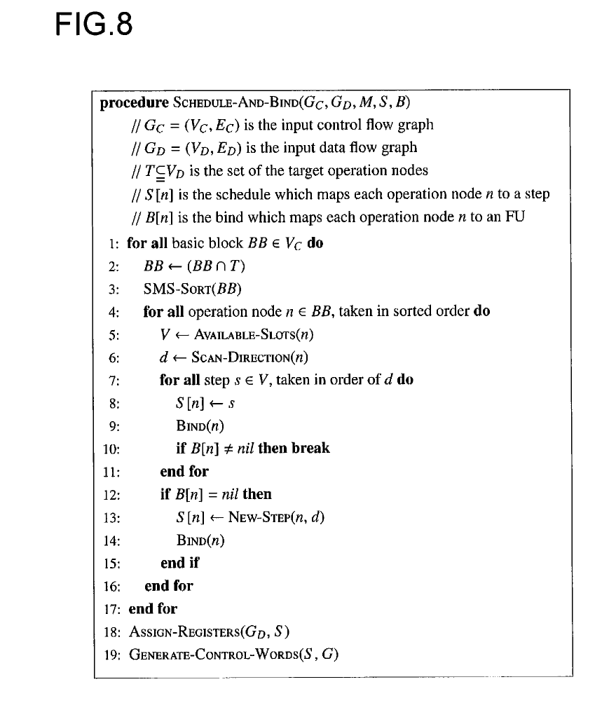

The incremental scheduling-binding synthesis performs scheduling and binding simultaneously. More specifically, first, after it is determined (scheduled) at which control step n is executed with respect to each operation node n V_{D}, it is determined (bound) at which function unit n is executed. The procedures of the scheduling shown in FIG. 8 is based on the swing modulo scheduling by “J. Llosa, “Swing modulo scheduling: A lifetime-sensitive approach,” in Proc. IEEE Int. Conf. on Parallel Architecture and Compilation Techniques (PACT), October 1996, pp. 80 to 87.”

The scheduling order of the set (BB∩T) of operation nodes is set based on the swing modulo scheduling to each basic block BB (third column, procedure SMS-Sort( )). The quality of the scheduling largely depends on the scheduling order. The swing modulo scheduling takes the operation node over the critical path as the first priority node, and sets the scheduling order so that the lifetime of a variable becomes minimum. Each operation node n is selected (fourth column) in the set scheduling order, and the following processes are repeated.

A set S of the control steps where n can be scheduled is set through a procedure Available-Slots ( ) (fifth column). Each control step of the set S is selected in the order set through a procedure Scan-Direction ( )(sixth column), and binding is attempted (ninth column). When no allocation is found, a new control step is inserted (New-Step ( )), and binding is performed again (12 to 15th columns).

Next, register allocation Assign-Registers ( ) is performed, and each variable is allocated to the register in the register file 17. In this stage, all local variables are certainly allocated to the registers. That is, no memory spill is performed. According to this scheme, a register allocating algorithm that ensures the optimality when the formula expressed in the control data flow graph is in the SSA form (see “P. Brisk, F. Dabiri, R. Jafari, and M. Sarrafzadeh, “Optimal register sharing for high-level synthesis of SSA form programs”, IEEE Trans. Computer-Aided Design, vol. 25, no. 5, pp. 772 to 779, May 2006”) is adopted. Eventually, a control program is generated based on the scheduling and binding results through a procedure Generate-Control-Words ( ).

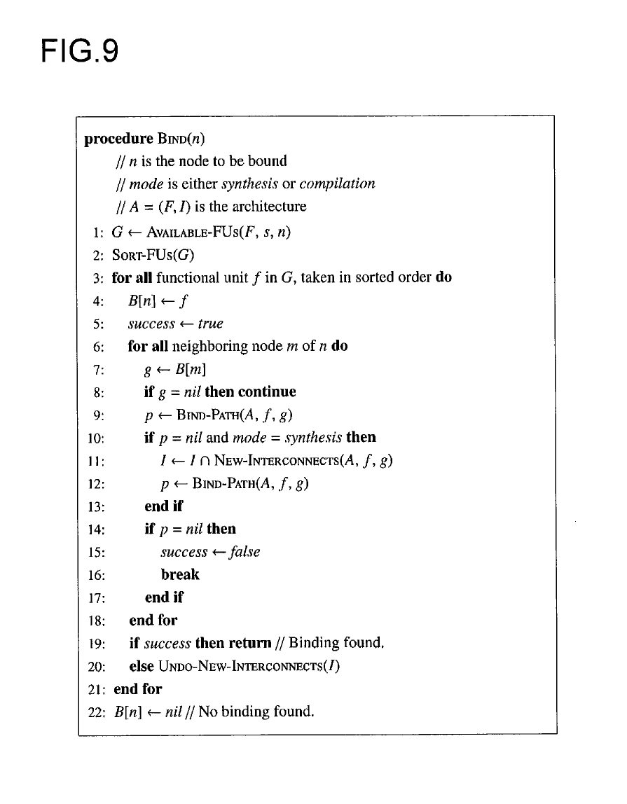

FIG. 9 shows a procedure of binding. First, a set of function units allocatable to an operation node n is obtained through a procedure Available-FUs ( ). Subsequently, a set of the function units are sorted based on the cost of binding through a procedure Sort-FUs ( ). The cost of allocating the operation node n to a function unit f is a wiring cost necessary to be added at the time of allocation. The operation node n is allocated to the function unit f in the order of sorting, and is coupled to a function unit g corresponding to an operation node m adjacent to the function unit f.

When there is a data edge between the operation node m and the operation node n, it is expressed that the two nodes adjoin with each other. When the operation node m is allocated to the function unit g already, the function unit f and the function unit g are coupled together through a procedure Bind-Path ( ). At this time, for the coupling of the function unit f with the function unit g, a wiring, a multiplexer, and a register port are combined. If the operation node m and the operation node n are scheduled to different control steps, binding is performed in such a way that an operation result is stored in the register.

If there is no such a path between the operation node m and the operation node n, a new wiring is inserted through a procedure New-Interconnects ( ) to perform binding again. At the time of compiling, no New-Connection ( ) is executed. This is the only difference between the synthesis and the compilation. If a path is not still found, all wirings introduced through the most recent repeating are eliminated (Undo-New-Interconnects ( )), and a next function unit candidate fεG is allocated to the operation node n.

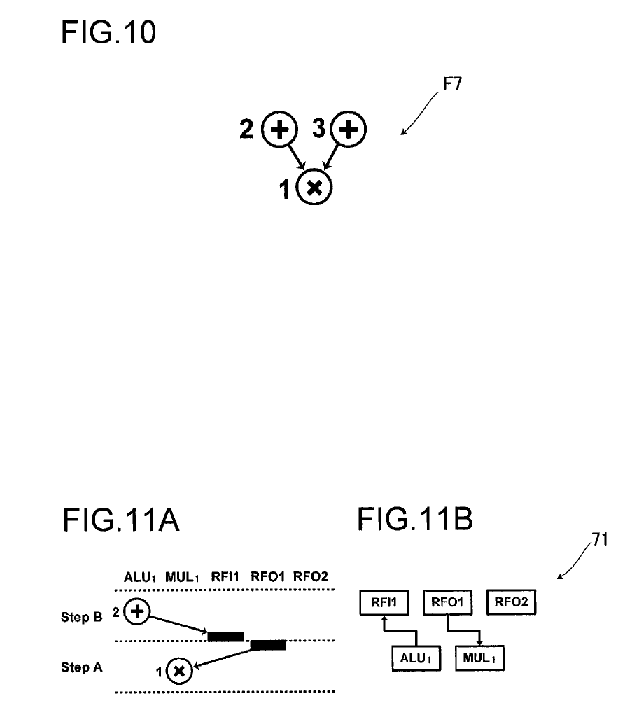

Next, an explanation will be given of the incremental scheduling-binding synthesis with reference to FIG. 10 showing an illustrative data flow graph F7. First, three operation nodes 1, 2, and 3 are sorted through the swing modulo scheduling. Numbers in FIG. 10 indicate the scheduling orders. FIG. 11A indicates the scheduling-binding results of the first two operation nodes 1 and 2. An MUL1 (corresponding to the multiplier 13 in FIG. 1) is allocated to the operation node 1 which has an input coupled to the reading port RFO1 coupled to the register file 17. An ALU1 (corresponding to the ALU₁ 11 in FIG. 1) is allocated to the operation node 2, and has an output coupled to the writing port RFI1 coupled to the register file 17. As shown in FIG. 11B, according to a data path 71 corresponding to such a scheduling result, respective wirings are provided between the ALU1 and the writing port RFI1 and between the reading port RFO1 and the MUL 1.

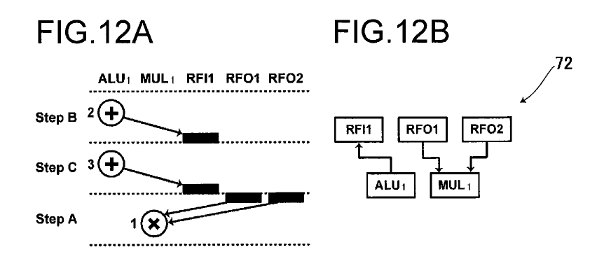

The operation node 3 is subsequently bound with a control step B (step B in the figure). As shown in FIG. 11A, according to the scheduling result, since the ALU1 is already allocated to the control step B, as shown in FIG. 12A, a new control step C (step C in the figure) is inserted, and the ALU1 is allocated to the operation node 3 in the control step C.

A data edge is present between the operation node 3 and the operation node 1 (see FIG. 10), the operation node 1 is scheduled to a control step A, the operation node 3 is scheduled to the control step C (step C in the figure), and the different control steps A and C are subjected to scheduling. Hence, according to such a scheduling result, as shown in FIG. 12A, the operation node 1 is coupled to the reading port RFO2 coupled to the register file 17, and the operation node 3 is coupled to the writing port RFI1 coupled to the register file 17. According to the data path 71 shown in FIG. 11B, there is a wiring between the ALU1 and the writing port RFI1, but there is no wiring between the reading port RFO2 and the MUL1. Hence, as shown in FIG. 12B, a new wiring is eventually added between the reading port RFO2 and the MUL1, thereby generating a data path 72 corresponding to the scheduling result.

### (5) Operation and Advantage

According to the above-explained configuration, the accelerator 1 includes the integrated hard-wired logic controller 4 which is configured by a hard-wired logic having a prefixed logic, and which successively generates control signals that are instructions of predetermined arithmetic processing in accordance with the preset order of the program counters 1 to 3, and the fixed function is realized by such an integrated hard-wired logic controller 4. Accordingly, the accelerator 1 is made compact by what corresponds to the lack of extra circuit structures like a memory, thereby improving the process speed and the power efficiency.

Moreover, the accelerator 1 is provided with the program counter patch 30 which receives the program counters 1 to 3 from the integrated hard-wired logic controller 4, and which replaces the predetermined program counter 2 in the program counters 1 to 3 with the additional program counter 4, and the control signal patch 31 that stores the state cs4 that is a modified arithmetic processing instruction in association with the additional program counter 4.

Hence, according to the accelerator 1, when the control signal patch 31 receives counter data indicating the additional program counter 4 from the program counter patch 30, instead of the control signal indicating the content of the program counter 2 and output by the integrated hard-wired logic controller 4, the state cs4 that is a modified arithmetic processing instruction associated with the additional program counter 4 is transmitted as a control signal to the data path 3.

Therefore, according to the accelerator 1, even if a modification to the circuit configuration becomes necessary after the production because of a specification change or a false design, it is unnecessary to newly design and produce an accelerator having undergone a function modification through the high-level synthesis, and the data path 3 can execute the arithmetic processing after the function modification in accordance with the state cs4 without a modification of the integrated hard-wired logic controller 4 itself.

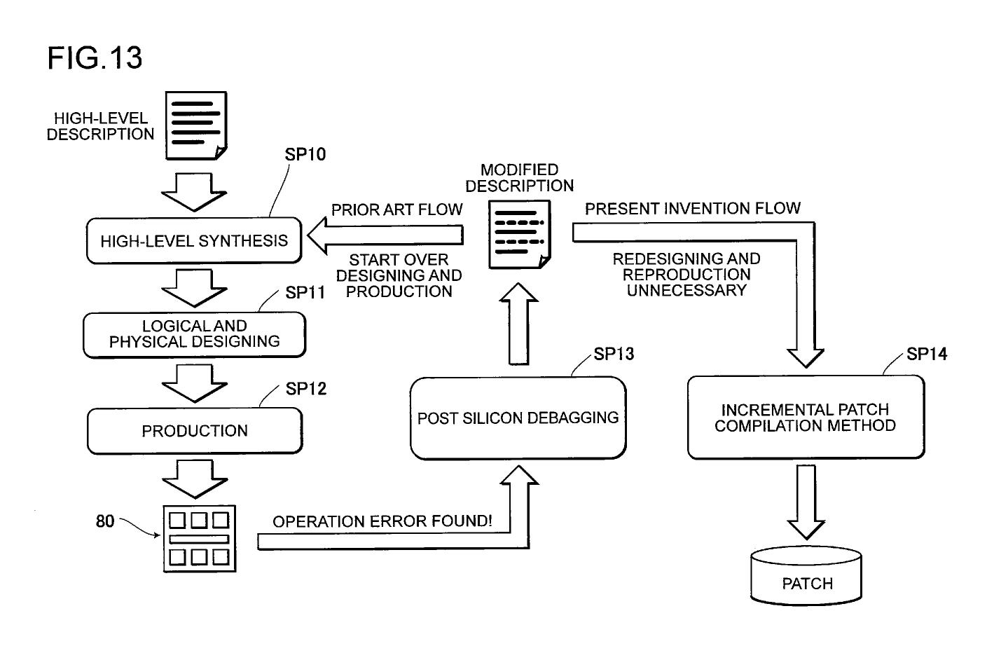

That is, as shown in FIG. 13, in general, when a fixed-function accelerator 80 configured by a hard-wired logic is produced, logical and physical designing (step SP11) of a configuration, etc., of the hard-wired logic is performed through the high-level synthesis (step SP10) utilizing high-level descriptions, and the fixed-function accelerator 80 based on the initial designing is produced (step SP12). Thereafter, when an operation defect on the produced accelerator 80 is found, a step of specifying a necessary modification to accomplish the operation satisfying the specification initially designed is executed (step SP13), modified descriptions with the defect modified are generated, logical and physical designing (step SP11) of a configuration, etc., of the hard-wired logic is performed again through the high-level synthesis (step SP10), and the accelerator 80 having undergone the modification of the initial designing is produced (step SP12).

In contrast, according to the present invention, by applying the patch compiling method based on the integer linear programming through modified descriptions (step SP14), the patch stored in the control signal memory 40 can be compiled, and unlike the conventional technology, it becomes unnecessary to start over the production from the beginning including the logical and physical designing (step SP11) and the reproduction of the accelerator itself (step SP12), etc.

The accelerator 1 generates, at the time of the designing of the accelerator 1, a plurality of modified data flow graphs including operation nodes added and data edges changed from the data flow graph generated through the high-level synthesis based on the initially designed specification, and the function units are selected in such a way that the arithmetic processing of the modified data flow graphs can be executed within a range where the predetermined performance constraint is satisfied. Hence, the data path 3 having all function units selected is used.

Therefore, according to the accelerator 1, it becomes possible to provide the comparator 10, the ALU₁ 11, the ALU₂ 12, the multiplier 13, and the barrel shifter 14 (function units), etc., in consideration of a latent function modification in advance that may occur because of a specification change and a false design after production, and even if a minor function modification is performed on the control unit 2 after the production, the probability of having the function units to be necessary to satisfy the performance constraint even after the function modification increases, and thus the performance yield after the function modification can be maximized.

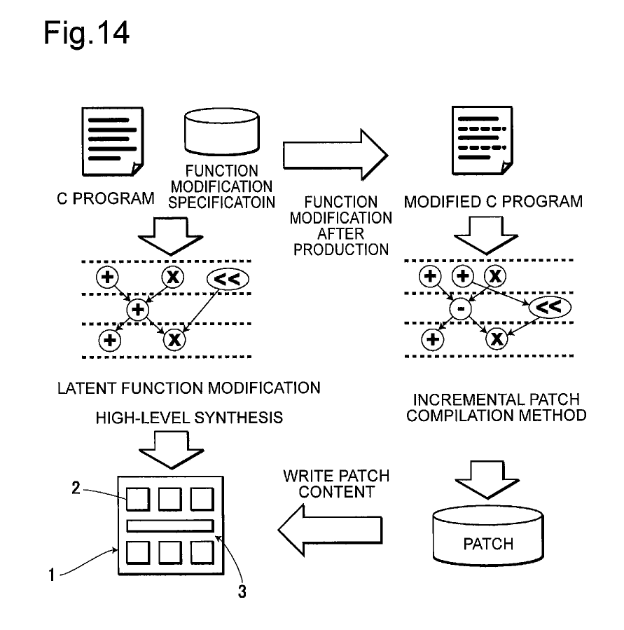

FIG. 14 is a schematic view summarizing the outline of the accelerator 1 of the present invention. As shown in FIG. 14, according to the accelerator 1, at the time of designing, a plurality of modified data flow graphs are generated in consideration of a latent function modification based on the initially designed specification using a C program and a function modification specification indicating an addition of an operation node and a change in a data edge, etc., and the data path 3 that can execute the arithmetic processing of the modified data flow graph within a predetermined performance constraint is generated through the high-level synthesis.

According to the accelerator 1, when a function modification becomes necessary because of a specification change and a false design after production, the patch is generated based on the above-explained patch compilation method from the design descriptions after the function modification using the C program, and the content of this patch is written in the control signal memory 40, thereby enabling the function modification.

Moreover, according to the accelerator 1, the integrated hard-wired logic controller 4 is provided which includes the IDCT control circuit 25, the FIR control circuit 26, and the CRC control circuit 27 realizing different fixed functions, and even if any one of the IDCT control circuit 25, the FIR control circuit 26, and the CRC control circuit 27 is selected, the function units that can execute the IDCT process, the FIR process, and the CRC process are selected and provided in advance. Hence, according to the accelerator 1, even if the application thereof changes after the production, the function modification can be easily made to a circuit configuration that executes any one of the IDCT process, the FIR process, and the CRC process in accordance with such an application change.

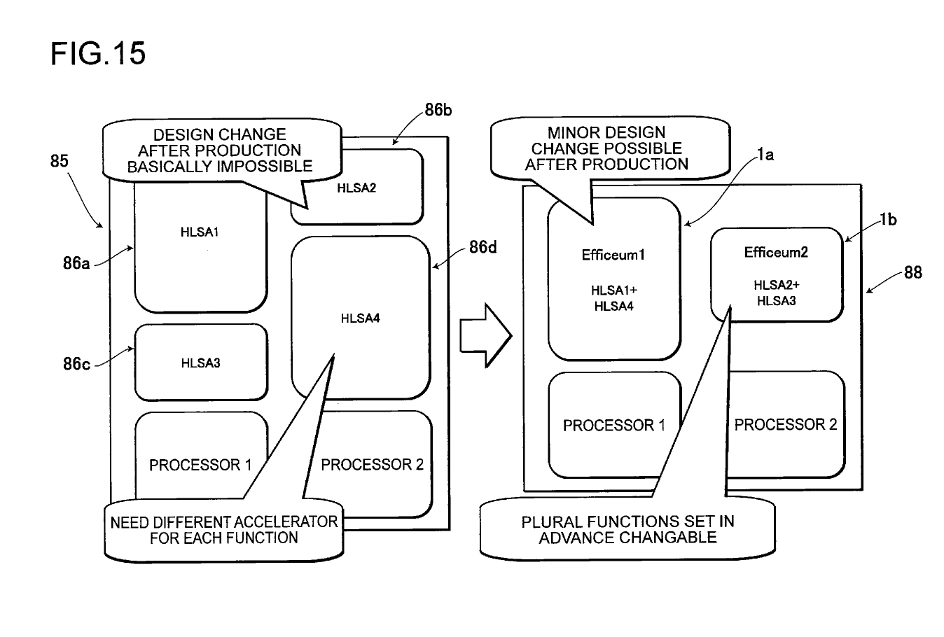

As shown in FIG. 15, according to a conventional integrated circuit 85, when, for example, any one of the IDCT process, the FIR process, and the CRC process is selectively enabled, accelerators 86a, 86b, 86c, and 86d designed individually by the high-level synthesis are provided process by process. Moreover, according to the conventional integrated circuit 85, respective accelerators 86a, 86b, 86c, and 86d are configured by a hard-wired logic and realize respective fixed functions, and thus a design change after the production is hardly permitted.

In contrast, as shown in FIG. 15, according to an integrated circuit 88 using accelerators 1a and 1b of the present invention each including the patch circuit 5 (see FIG. 1), the data path which is individually provided for each process according to the conventional technology can be communalized, and the area of the whole integrated circuit 88 can be reduced by what corresponds to such communalization, thereby accomplishing the downsizing. Moreover, according to the integrated circuit 88, each of the accelerators 1a and 1b is provided with the patch circuit 5 so that the use of the above-explained patch circuit 5 enables a minor function modification for each of the accelerators 1a and 1b even after the production. Accordingly, if a function modification is made after the production, the integrated circuit 88 is realized which enables the function modification while maintaining the circuit configuration at the time of production.

According to this embodiment, the accelerator 1 has the control signal memory 40 that has a memory capacity just sufficient to permit changing of only some control signals, thereby reducing the power consumption even if the number of readout becomes extremely large.

According to the above-explained configuration, the accelerator 1 has the integrated hard-wired logic controller 4 which is configured by a hard-wired logic with a fixed logic in advance and which newly transmits a control signal that is the state cs4 having undergone the function modification to the data path 3 instead of the control signal of the program counter 2 needing the function modification among the control signals successively generated in the order of the program counters 1 to 3, and thus the data path 3 can execute the arithmetic processing having undergone the function modification.

Therefore, according to the accelerator 1, the integrated hard-wired logic controller that mainly realizes the predetermined function is configured by the hard-wired logic to accomplish the downsizing and the improvement of the process speed and the power efficiency. Furthermore, even if the function modification becomes necessary after the production by a specification change and a false design, the patch circuit 5 enables the function modification without the redesigning of the integrated hard-wired logic controller itself by the high-level synthesis, resulting in the cost reduction by what corresponds to such unnecessity of the redesigning. Hence, the accelerator 1 is provided which can accomplish the downsizing and the improvement of the process speed and the power efficiency, and which can dramatically reduce the costs necessary for the function modification after the production.

### (6) Examination Result

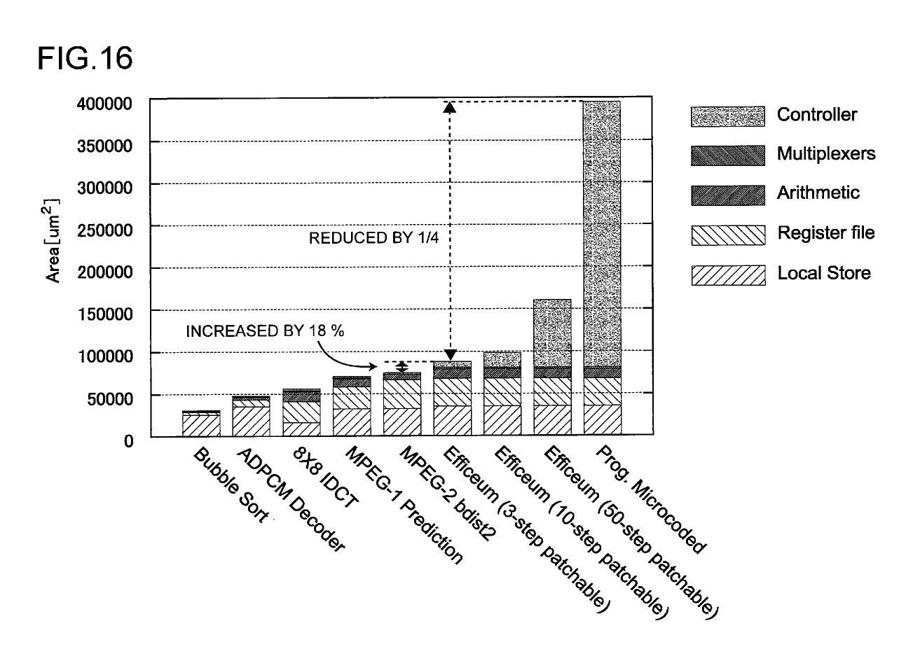

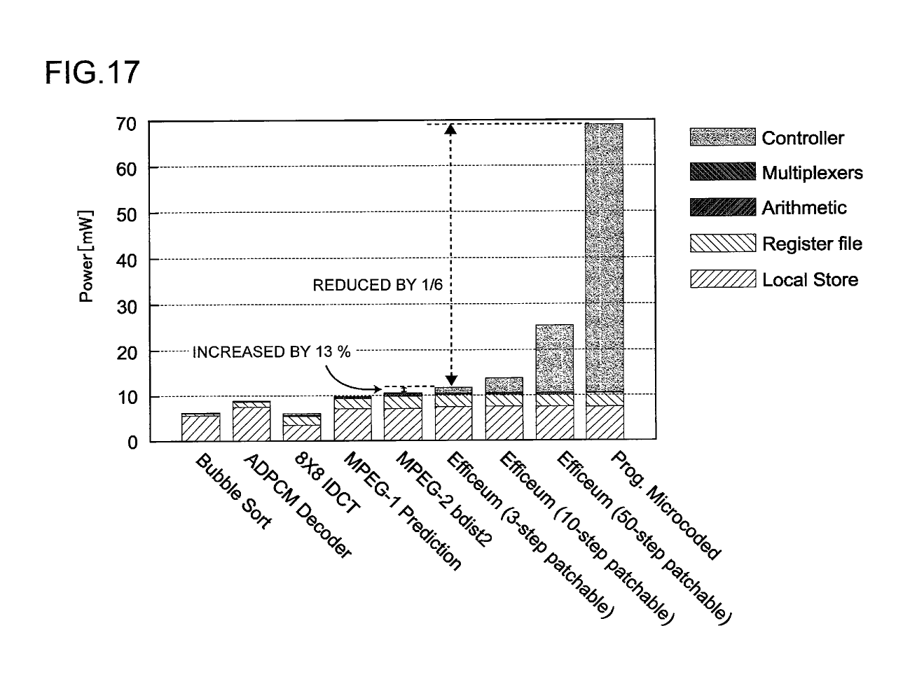

Next, how much the area of the whole circuit configuration of the accelerator 1 of the present invention and the power consumption thereof at the time of operation differ from those of a conventional fixed-function accelerator that can realize only one function and a typical general-purpose processor having a good programmability that enables a function modification were examined. FIG. 16 shows an examination result of comparing the area of a circuit configuration of the accelerator 1 of the present invention with those of the conventional fixed-function accelerator and the typical general-purpose processor. FIG. 17 shows an examination result of comparing the power consumption of the accelerator 1 of the present invention with those of the conventional fixed-function accelerator and the typical general-purpose processor.

As the conventional fixed-function accelerators that were comparative examples, five circuits: “bubble sort”; “ADPCM Decoder”; “8×8 IDCT (8×8 Inverse Discrete Cosine Transform)”; “MPEG-1 Prediction (MPEG-1 prediction function)”; and “MPEG-2 bdist2 (MPEG-2 bdist function)” as high-level synthesized accelerators with a fixed function and described by the C language were prepared. In FIG. 16, the general-purpose processor is indicated as “Prog. Micricided”.

Moreover, as the accelerator 1 of the present invention, three kinds of accelerators 1 which employed a circuit configuration capable of executing all of the five functions “bubble sort”, “ADPCM Decoder”, “8×8 IDCT”, “MPEG-1 Prediction”, and “MPEG-2 bdist2” that were the above-explained conventional fixed-function accelerators, and which had the maximum number Mmax of modified control steps of 3, 10, and 50, respectively, were prepared.

In the accelerators 1 of the present invention, an LLVM compiler infrastructure (C. Lattner and V. Adve, “LLVM: A compilation framework for lifelong program analysis & transformation,” in Proc. IEEE/ACM Int. Symp. on Code Generation and Optimization (CGO), May 2004, p. 75) was applied to the process of analyzing an input C program and establishing a control data flow graph (CDFG) in an SSA format. Moreover, according to the accelerators of the present invention, the above-explained “(4) Data Path Synthesis Method” was applied to the synthesis of a data path, and a data path in consideration of a latent variety was used. That is, according to the accelerators 1 of the present invention, a data path was synthesized which was optimized for execution of plural functions. A Gurobi Optimizer (Gurobi Optimizer Reference Manual, Version 3.0. Gurobi Optimization, Inc., 2010) was used as a solver for the integer linear programming applied at the time of the production of the accelerators 1 of the present invention.

Moreover, an examination of comparing the areas of respective circuits: a control circuit (Controller); a multiplexer (Multiplexers); a computing unit (Arithmetic); a register file (Register file); and a local store (Local Store) was also carried out.

In order to carry out a fair comparison for the accelerator 1 of the present invention, the conventional fixed-function accelerator, and the typical general-purpose processor, the operating frequency of all circuits was set to be 200 MHz. Moreover, FreePDK45 (FreePDK45, http://www.eda.ncsu.edu/wiki/FreePDK45:Contents. North Carolina State University, 2010) that was a virtual technology for a 45 nm process was applied for area and power consumption evaluations. Furthermore, a standard cell library provided by Nangate Corporation was used, the Design Compiler made by Synopsys Corporation was used for a logical synthesis, and the Prime Time made by Synopsys Corporation was used for a static timing analysis, and area and power consumption evaluations.

It was confirmed that, among the plurality of accelerators 1, the accelerator 1 having the maximum number Mmax of modified control steps that was 3 was capable of reducing the area by 78% and the power consumption by 83% in comparison with the general-purpose processor. Moreover, the accelerator 1 having the maximum number Mmax of modified control steps that was 3 had an overhead of 18% in area and 13% in power consumption in comparison with “MPEG-2 bdist2” which was the circuit having the maximum area among the conventional fixed-function accelerators. It becomes clear that the accelerator 1 of the present invention enables a change of the execution times of plural functions and a function modification after production, while at the same time, realizes the area and the power consumption which are substantially equal to those of the conventional fixed-function accelerator, and it is confirmed that the accelerator of the present invention is superior to the conventional technology from the standpoint of the area and the power consumption.

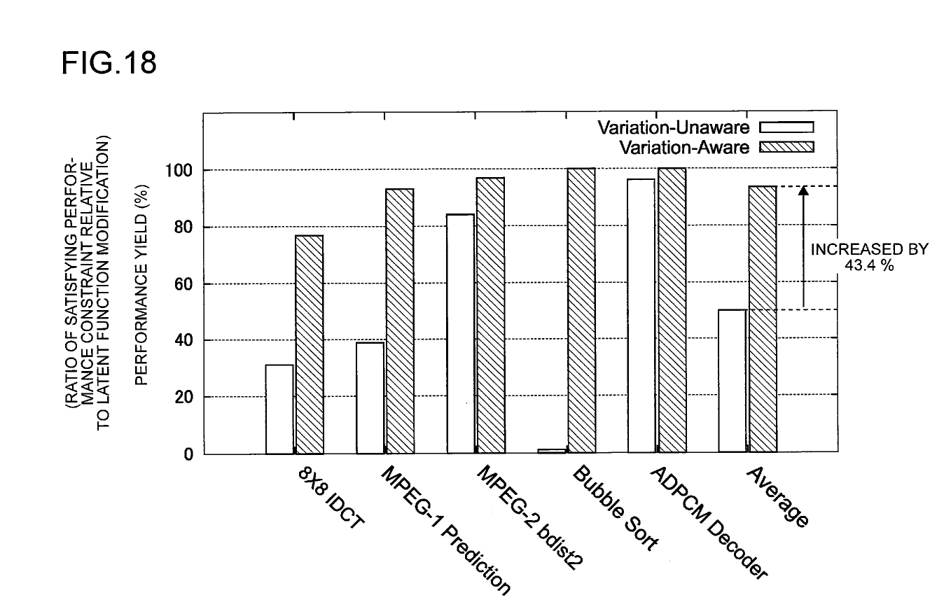

Next, an examination of comparing the performance yield was carried out between a data path generated in consideration of a function modification after production based on the “(4) Data Path Synthesis Method” and a data path used in the conventional fixed-function accelerator, and a result shown in FIG. 18 was obtained. In FIG. 18, an accelerator 1 having the data path in consideration of a variety is indicated as “Variation-Aware”, and a conventional accelerator having a data path not in consideration of a variety is indicated as “Variation-Unaware”.

The above-explained LLVM compiler infrastructure was applied to the process of analyzing an input C program and establishing a CDFG in an SSA format. When the C program contained a function call, a single function was generated through a function in-lining. Moreover, a description by the System C language could be an input and an accelerator was synthesized for each module. At this time, a plurality of modules were communicated with each other via a local store. The RTL description of the synthesized accelerator could be output in the Verilog HDL language, and the control program could be output in various formats.

As a comparative example, a data path which was equal to a data path generated by a typical high-level synthesis tool not in consideration of a variety was synthesized. Respective areas of a function unit, a multiplexer, a memory element, and a wiring were estimated through a Rohm 0.18 μm technology.

The data path provided for the accelerator 1 of the present invention generated a variety set having the initially designed data flow graph modified by adding an operation node and changing a data edge. When generating such a data path, a constraint was given in such a way that the increase of the operation nodes became equal to or smaller than 3% at total, and 100 different variants were generated for each designing. A data path having a tolerant against a function modification was synthesized in consideration of such variants.

Next, compiling was performed on the data path that was the comparative example not in consideration of a variety and the data path in consideration of the variety with a design variety set generated through the above-explained method being as an input, and 100 execution steps were obtained. The performance yield was a rate within 103% of the number of execution steps of the initial design in the 100 execution steps. It is confirmed from FIG. 18 that the data path of the present invention improves the performance yield by 43.4% at the area overhead of 2.8% as a whole.

### (7) Other Embodiments

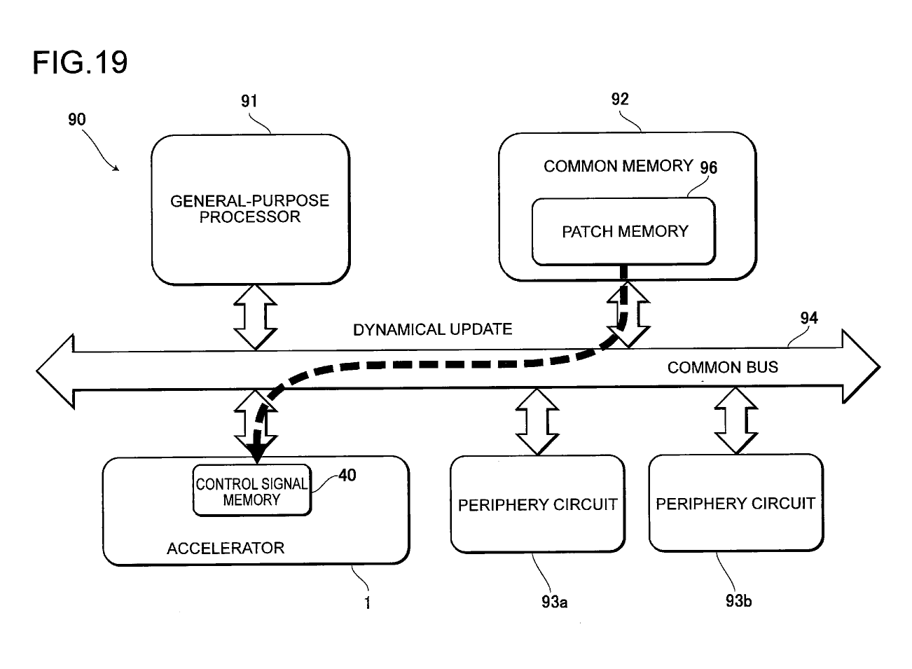

For example, in FIG. 19, reference numeral 90 indicates an integrated circuit that is a system on chip integrating successive and necessary functions (systems) on a semiconductor chip, the accelerator 1 of the present invention, a general-purpose processor 91, a common memory 92, and periphery circuits 93a and 93b are coupled to a common bus 94, and various data can be exchanged between respective circuits.

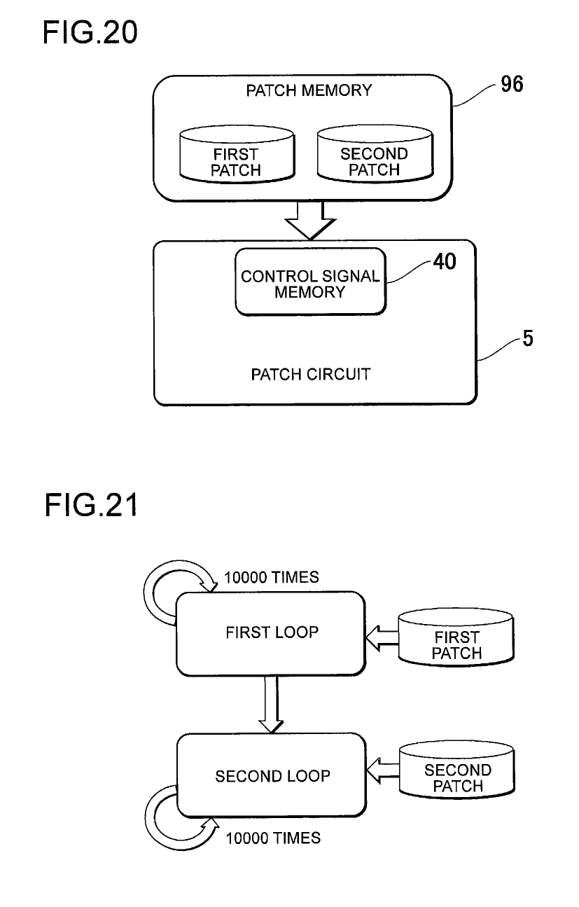

In this case, the accelerator 1 has the control signal memory 40 coupled with a patch memory 96 of the common memory 92 via the common bus 40, and data stored in the patch memory 96 can be transferred to the control signal memory 40 as needed. In practice, as shown in FIG. 20, the patch memory 96 has a larger memory capacity than that of the control signal memory 40, and stores in advance all of a first patch and a second patch necessary for the control signal memory 40.

The control signal memory 40 reads and dynamically updates either one of the first and second patches from the patch memory 96 as needed, and for example, changes the stored content from the first patch to the second patch, or changes the stored content from the second patch to the first patch.

Hence, according to the accelerator 1, as shown in FIG. 21, first, the control signal memory 40 stores the first patch, and when the data path 3 executes an arithmetic processing (a first loop) repeated by predetermined times (e.g., 10000 times) in the order according to the program counters and the additional program counter, the arithmetic processing based on the content of the first patch is enabled.

Next, the accelerator 1 reads the second patch from the patch memory 96, and stores the second patch instead of the first patch stored in the control signal memory 40. Hence, when data path 3 executes an arithmetic processing (a second loop) repeated by predetermined times (e.g., 10000 times) in the order in accordance with the program counters and the additional program counter, the accelerator 1 can execute the arithmetic processing based on the content of the second patch.

In the above-explained embodiment, the explanation was given of the case in which the patch memory 96 is provided at the exterior of the patch circuit 5, but the present invention is not limited to this case, and the patch memory 96 may be provided in the patch circuit 5.

According to the accelerator 1 employing the above-explained configuration, the scale of a function modification to which the patch can be applied is restricted by the memory capacity of the control signal memory 40. However, if the content stored in the control signal memory 40 is updated to the content of the patch memory 96, the patch can be easily changed to the different patch content even if the scale of the function change is large by updating the content of the control signal memory 40 to the patch stored in the patch memory 96.

Moreover, according to the accelerator 1, in general, when the memory capacity increases, the power consumption becomes large and the power consumption efficiency also becomes poor. However, the number of readout from the patch memory 96 is twice, and the number of readout from the control signal memory 40 is 20000 times. Since the number of readout from the patch memory 96 is remarkably small, the power consumption by the patch memory 96 can be reduced so as to be substantially ignorable.

Furthermore, according to the accelerator 1, the patch can be changed from the first patch to the second patch even during the execution of the arithmetic processing by the data path 3 based on the content of the control signal memory 40. Hence, the same advantage when the memory capacity of the control signal memory 40 is increased can be obtained in practice.

The present invention is not limited to the above-explained embodiment, and can be changed and modified in various forms without departing from the scope and spirit of the present invention. For example, in the above-explained embodiment, the IDCT control circuit 25, the FIR control circuit 26, or the CRC control circuit 27 is provided as a circuit configuration which realizes plural different functions and which is provided in the integrated hard-wired logic controller 4, but the present invention is not limited to this configuration. Various other circuit configurations, such as an FFT control circuit and a DCT control circuit, may be provided.

According to the above-explained embodiment, the explanation was given of the case in which the content of the patch to be stored in the control signal memory 40 is generated through the patch compilation method based on the integer linear programming, but the present invention is not limited to this case. It is fine as far as a patch enabling a function modification is generated by storing in the additional program counter, and the patch can be generated through various other techniques.

Moreover, according to the above-explained embodiment, various techniques can be applied in addition to the above-explained data path synthesis method as far as a function unit can be selected which is necessary to satisfy the performance constraint after the function modification.

Furthermore, according to the above-explained embodiment, the explanation was given of the case in which the largeness determination unit 39 determines whether or not the value of the counter data from the program counter patch 30 is within the maximum value S_{F}, the control signal from the integrated hard-wired logic controller 4 is transmitted to the data path 3 when the value of the counter data is within the maximum value S_{F} based on the determination result by the largeness determination unit 39, whereas the control signal from the control signal memory 40 is transmitted to the data path 3 when the value of the counter data exceeds the maximum value S_{F}, but the present invention is not limited to this case. The integrated hard-wired logic controller 4 and the control signal memory 40 may respectively determine for the value of the counter data from the program counter patch 30 whether or not the counter data triggers generation of respective control signals without the largeness determination unit 39, and may transmit corresponding control signals to the data path 3 in accordance with respective determination results.

### (8) Accelerator of Another Embodiment

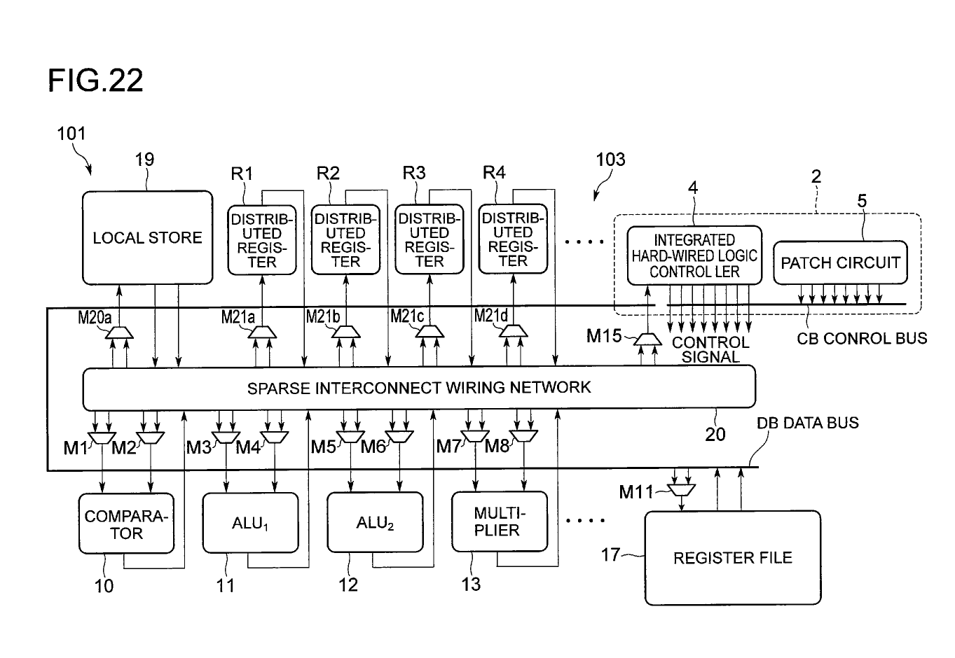

In FIG. 22 where the elements corresponding to those in FIG. 1 are denoted by the same reference numerals, a reference numeral 101 indicates an accelerator of another embodiment, and the accelerator 101 differs from the accelerator 1 in a point that the accelerator 101 employs a configuration in which in addition to the register file, distributed registers R1, R2, R3, R4, etc., are associated with, in the one by one manner, the function units, such as the comparator 10, the ALU₁ 11, the ALU₂ 12, the multiplier 13 (to simplify the explanation, the other function units are omitted). Such an accelerator 101 stores the operation result obtained by each function unit into each of the distributed registers R1, R2, R3, and R4, etc., associated with each of the function unit, and reads the operation results stored in the distributed registers R1, R2, R3, and R4, etc., as needed to use the read operation results for the next arithmetic processing.

The distributed registers R1, R2, R3, and R4, etc., have respective inputs coupled to the sparse interconnect wiring network 20 through respective multiplexers M21a, M21b, M21c, and M21d, etc., and a data bus DB, and have respective outputs coupled to the sparse interconnect wiring network 20 through the data bus DB. Each of such distributed registers R1, R2, R3, and R4, etc., is coupled with a function unit associated in advance, and stores the operation result only from the associated function unit, and has no unnecessary coupling with the plurality of other function units. Accordingly, no intensive access from the plurality of function units at the same time occurs, and the highly efficient arithmetic processing can be carried out, thereby accomplishing a high performance.

The accelerator 101 has the integrated hard-wired logic controller 4 and the patch circuit 5 coupled together through a control bus CB, and various data can be exchanged between the integrated hard-wired-logic controller 4 and the patch circuit 5 through the control bus CB. The control circuit 2 comprehensively controls various function units, such as the distributed registers R1, R2, R3, and R4, etc., the comparator 10, the ALU₁ 11, the ALU₂ 12, the multiplier 13, the register file 17, and the local store 19, directly transmits a control signal output by the control circuit 2 to each function unit, and causes each function unit to execute various processes like calculation based on the control signal. All signals in the circuit in the accelerator 101 are either one of calculation data used for an arithmetic processing like respective values of the distributed registers R1, R2, R3, and R4, etc., and a multiplication result, and a control signal, the sparse interconnect wiring network 20 is utilized for only exchanging of the calculation data.

A data path 103 stores, when executing an arithmetic processing base on the control signal from the control circuit 2, an operation result obtained by each function unit that is the comparator 10, the ALU₁ 11, the ALU₂ 12, and the multiplier 13 in each of the distributed registers R1, R2, R3, and R4, etc., associated with that function unit, and transmits the operation result stored in each of the distributed registers R1, R2, R3, and R4, etc., to the function unit that will execute the next arithmetic processing.

In addition, the register file 17 is coupled with various function units, such as the comparator 10, the ALU₁ 11, the ALU₂ 12, and the multiplier 13, the plurality of distributed registers R1, R2, R3, and R4, etc., the local store 19, and the integrated hard-wired logic controller 4 through the data bus DB, and stores various data, such as an operation result of each function unit and a global variable value from the local store 19, in the internal register as needed, or transmits various data stored in such a register to each function unit.

In practice, the register file 17 has an input coupled with the data bus DB through the multiplexer M11, and has an output coupled with the data bus DB. The auxiliary function unit designed to be used when a function modification is performed is provided with no unique distributed registers R1, R2, R3, and R4, etc., that store an operation result of such an auxiliary function unit. Accordingly, the register file 17 receives the operation result of the auxiliary function unit to be used for an arithmetic processing after the function modification through the data bus DB, and stores the received operation result in the predetermined register in the register file 17.

In practice, when only a predetermined fixed function defined in advance by the data path 103 is realized, the accelerator 101 stores the operation results in the distributed registers R1, R2, R3, and R4, etc., associated with respective function units, and executes an arithmetic processing. Thereafter, the accelerator 101 allocates the register file 17 to the auxiliary function unit to be used after a function modification when the minor function modification is made by the patch circuit 5 due to a specification change and a false design, and stores the operation result obtained by such an auxiliary function unit in the predetermined register in the register file 17, thereby executing a new arithmetic processing.

As explained above, the register file 17 is not used when the fixed function by the initial designing is realized but is used together with the auxiliary function unit after the function modification, and complements the distributed registers R1, R2, R3, and R4, etc., having a low flexibility to the function modification.

According to the accelerator 101 employing the above-explained configuration, when the predetermined fixed function is realized, the arithmetic processing is executed using the distributed registers R1, R2, R3, and R4, etc., associated in advance with respective function units. Hence, it is possible to selectively provide the distributed registers R1, R2, R3, and R4, etc., most appropriate for data exchange depending on the kind of each function unit, thereby improving the performance. Moreover, according to this accelerator 101, respective function units realizing the fixed functions access different distributed registers R1, R2, R3, and R4, etc., and thus no intensive access to one location in the register file 17 from the plurality of function units occurs, thereby distributing data exchange at the time of arithmetic processing to improve the efficiency.

Furthermore, according to this accelerator 101, thereafter, when the patch circuit 5 makes a minor function modification due to a specification change and a fault design and the auxiliary function unit not used before the function modification becomes newly used, the operation result from the auxiliary function unit is stored in the register file 17, which enables execution of a new arithmetic processing having undergone the function modification. As explained above, according to the accelerator 101, when the distributed registers R1, R2, R3, and R4, etc., are provided for respective function units, the register file 17 is also provided. Accordingly, a new arithmetic processing can be executed using the auxiliary function unit after the function modification.

### (9) Patch Compilation Method According to Another Embodiment

Next, an explanation will be given of a patch compilation method according to another embodiment of the above-explained “(3) Patch Compilation Method based on Integer Linear Programming”.

(9-1) Problem Formulation

It was already explained in “(4-2) Incremental Scheduling-Binding Synthesis”, but a control data flow graph (CDFG) is built with the high-level description (the C language program) of designing being as an input. It is presumed that a formula expressed by the data flow graph is a static single assignment (SSA) expression. The control data flow graph (CDFG) includes a control flow graph (CFG): G_{C}=(V_{C}, E_{C}) and a data flow graph (DFG): G_{D}=(V_{D}, E_{D}). The control flow graph (CFG) includes a control node V_{C} and a control edge E_{C}, each control node corresponds to the basic block, and each control edge represents a control flow between two control nodes. The basic block in this stage means a series of instructions not including a control instruction. The data flow graph (DFG) includes an operation node V_{D} and a data edge E_{D}, each operation node corresponds to a certain operation in designing and each data edge represents the dependency relation between operations.

The design description before and after a change can be expressed as a graph structure that is Difference-CDFG (Δ-CDFG). In the part Δ-CDFG, the set of operation nodes can be expressed as a sum set of four sets: V_{D}=V_{F}∪V_{N}∪V_{R}∪V_{F} is a set of nodes having no change, V_{N} is a set of added nodes, V_{R} is a set of deleted nodes, and V_{M} is a set of changed nodes. The changed node has only the input thereof changed. Hence, it is possible to cope with the changed nodes by maintaining the scheduling and the binding as those are but by changing only the control signal.

Conversely, it is necessary to perform new scheduling and binding on the added nodes. The set of operation nodes in the control data flow graph (CDFG) before a change is V_{D}=V_{F}∪V_{R}∪V_{M}, and the set of the operation nodes in the control data flow graph (CDFG) after the change is V_{D}=V_{F}∪V_{N}∪V_{M}. For example, when arithmetic processing of the initially designed data flow graph F1 (see FIG. 3A) and the data flow graph F2 having undergone the function modification (see FIG. 4A) are classified, V_{D}={N1, N2, N3}, V_{N}={N6}, V_{R}={N4}, and V_{M}={N5}. The CFG of Δ-CDFG is consistent with the CFG after the change. That is, the deleted nodes contained in V_{R} do belong to no control node (the basic block). Likewise, the data edge of Δ-CDFG is consistent with DFG after the change. That is, the deleted node contained in V_{R} is not coupled with the edge. Since the deleted node is deleted at last, and belongs to no control node, and no data edge thereof is present.

U={s1, s2, . . . } indicates a set of states of the control circuit. A data path D=(G, P) includes a set G={f1, f2, . . . } of the function units (FU), and a set P={r1, r2, . . . } of the registers. The registers mean not only the distributed registers R1, R2, R3, and R4, etc. shown in FIG. 22, but also respective registers in the register file 17. A schedule S:V_{D}→U represents a correspondence relation between each operation and the state for executing that operation, a bind F:V_{D}→G represents a correspondence relation between each operation and the function unit (FU) executing that operation, and a register bind R:V_{D}→P represents a correspondence relation between each operation and a register storing the result of that operation.

With respect to each operation node vεV_{F}∪V_{R}∪V_{M} of the control data flow graph (CDFG) before the change, the state is expressed as Sₒ(v), and the bound function unit (FU) and a register are expressed as Fₒ(v) and Rₒ(v), respectively. According to the incremental scheduling-binding for obtaining a patch, there is a problem of obtaining the state S(v) of the newly added node vεV_{N} and the bound function unit F(v) and the register R(v). The state corresponding to the added node and the changed node is referred to as a patch state that is stored in the patch circuit 5. The object of the above-explained problem is to obtain the incremental scheduling-biding that minimizes the patch states (i.e., minimizing the number of additional program counters modified in the patch shown in FIG. 4B).

(9-2) Algorithm of Incremental Scheduling-Binding of Another Embodiment

Next, an explanation will be given below of an algorithm that realizes the incremental scheduling-binding which minimizes the patch states as explained above. According to the incremental scheduling-binding explained below, it is also presumed that a designer obtains a difference between the initially designed data flow graph and a data flow graph having undergone a function modification, and a node desirably to be modified (e.g., desirable to change an addition to a subtraction) among the initially designed data flow graph is known beforehand.

According to this algorithm, a scheduling, a binding, and a register binding are performed simultaneously. The scheduling is to set at which state an operation node n is executed with respect to each operation node nεV_{D}, the binding is to set at which function unit the operation node n is executed, and the register binding is to set in which register the operation result of the operation node n is stored.

According to the accelerator, respective capacities of the memory and the register in the register file storing the patch are limited. Hence, according to this algorithm, it is desirable to minimize the use of such registers. Therefore, according to this algorithm, a Swing Modulo Scheduling algorithm (J. Llosa, Swing modulo scheduling: A lifetime-sensitive approach. In Proc. IEEE Int, Conf. on Parallel Architecture and Compilation Techniques (PACT), pages 80 to 87, October 1996) is fundamental.

According to this algorithm, the performance maximization is most preferential, and minimization of the retaining period of the variable (a time period while the operation result must be retained (stored) in the register) is optimized at the next preferential. The performance maximization is equivalent to minimization of the number of the patch states (minimization of the number of additional program counter added in the patch circuit 5), and minimization of the variable retaining period is equivalent to minimization of the use of the register (minimization of the time period while the operation result is retained in the register).

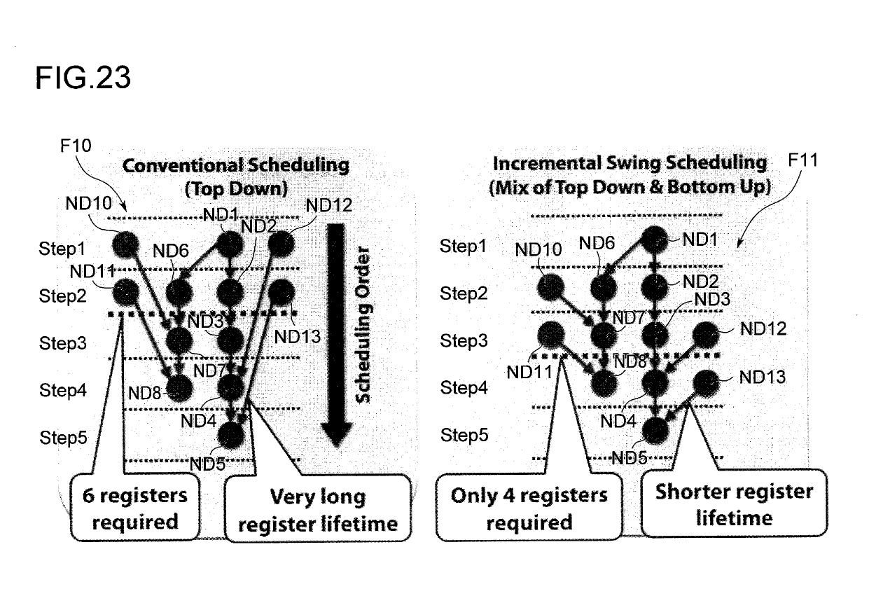

A data flow graph F10 shown in FIG. 23 is an illustrative scheduling of operation nodes ND10, ND11, ND12, and ND 13 without accomplishing performance maximization and minimization of the variable retaining period. According to this data flow graph F10, operations are executed in the order of from Step 1 to Step 5, and operation nodes ND1 to ND5 for executing predetermined operations are disposed in this order between the Step 1 to the Step 5. The data flow graph F10 has an operation node ND6 that executes an operation based on an operation result by the operation node ND1 executed in the Step 1 at the Step 2, has an operation node ND7 following the operation node ND6 in the Step 3, and an operation node ND8 is disposed in the Step 4.

According to the data flow graph F10, it is scheduled that the operation node ND10 executes an operation in the Step 1, gives the operation result to the operation node ND7 in the Step 3, and the operation node ND11 executes an operation in the Step 2, and gives the operation result to the operation node ND8 in the Step 4, Moreover, according to the data flow graph F10, scheduling is executed so that the operation node ND12 executes an operation in the Step 1, gives the operation result to an operation node ND4 in the Step 4, and the operation node ND13 executes an operation in the Step 2 and gives the operation result to an operation node ND5 in the Step 5.

According to the data flow graph F10 which does not accomplish performance maximization and minimization of variable retaining period, for example, when the state transitions from Step 2 to Step 3, it is necessary to retain respective operation results of the six operation nodes ND11, ND10, ND6, ND2, ND12, and ND13 in different registers, and thus the six registers are used. Moreover, according to the data flow graph F10, it is necessary to retain, for example, the operation result by the operation node ND13 executed in the Step 2 in the register for a long time across the Step 3 and the Step 4.

Conversely, according to such a data flow graph F10, when the performance maximization and the minimization of the variable retaining period are accomplished by the incremental scheduling-binding algorithm, a scheduling shown by a data flow graph F11 can be obtained. In practice, according to the data flow graph F11, the operation node ND10 that gives the operation result to the operation node ND7 in the Step 3 is executed in the Step 2 right before the Step 3, and the operation node ND11 that gives the operation result to the operation node ND8 in the Step 4 is executed in the Step 3 right before the Step 4, thereby minimizing the time period of retaining the operation results of the operation nodes ND10 and ND11 in the registers (the variable retaining period).

Moreover, according to this data flow graph F11, the operation node ND12 that gives the operation result to the operation node ND4 in the Step 4 is executed in the Step 3 right before the Step 4, and the operation node ND13 that gives the operation result to the operation node ND5 in the Step 5 is executed in the Step 4 right before the Step 5, and thus the time period of retaining those operation results of the operation nodes ND12 and ND13 (the variable retaining period) in the registers are minimized.

As a result, according to the data flow graph F11, when, for example, the state transitions from the Step 3 to the Step 4, respective operation results of the four operation nodes ND11, ND7, ND3, and ND12 are retained in different registers. That is, according to the data flow graph F11, when the state transitions from the Step 3 to the Step 4, the four registers are used, and thus the number of registers used in the above-explained data flow graph F10 (e.g., six registers are used when the state transitions from the Step 2 to the Step 3 in the above-explained data flow graph F10) is reduced, and thus the above-explained performance maximization is enabled.

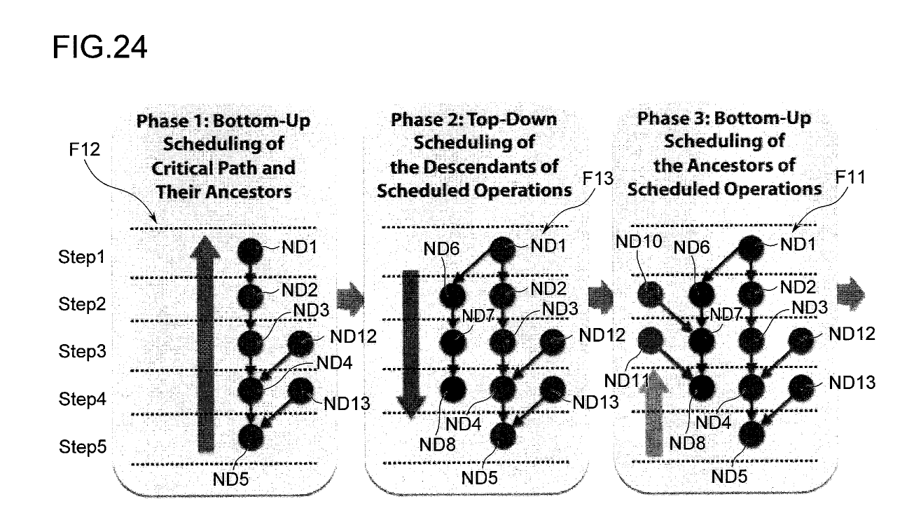

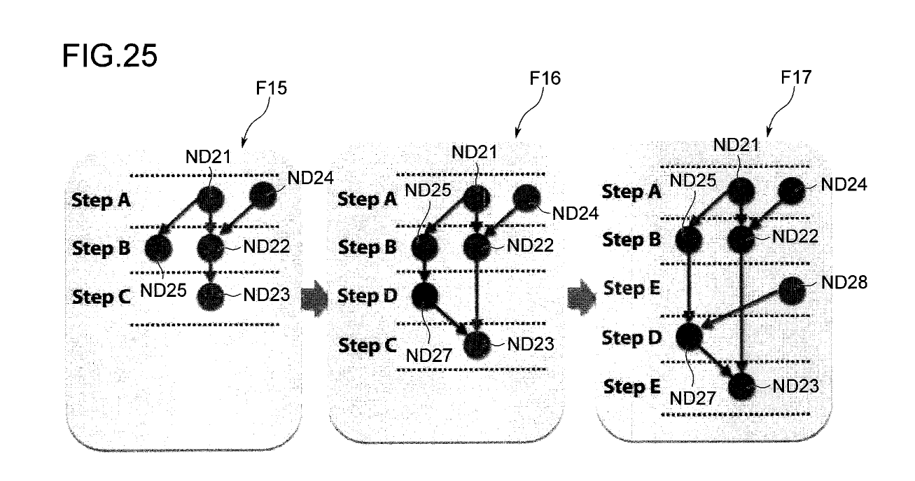

Next, an explanation will be given of the outline of such an algorithm accomplishing both performance maximization and variable retaining period minimization with reference to FIGS. 24 and 25. A data flow graph F12 shown in FIG. 24 shows a scheduling of adding the operation node ND12 that gives the operation result to the operation node ND4 in the Step 4 and the operation node ND13 that gives the operation result to the operation node ND5 in the Step 5 to the operation nodes ND1 to ND5 that execute successive operations from the Step 1 to the Step 5.

When, for example, the operation nodes ND12 and ND13 that give operation results to the already present predetermined operation nodes ND4 and ND5 are added, it is determined whether or not the additional operation nodes ND12 and ND13 can be allocated in the order of the Step 5, the Step 4, the Step 3, the Step 2, and the Step 1, from the latest Step 5 to the fastest Step 1, and the operation nodes ND12 and ND13 are added to the Steps 3 and 4 that are latest and the operation nodes can be allocated, thereby scheduling the operation nodes ND12 and ND13 to the latest Steps as possible.

Conversely, as is indicated by a data flow graph F13 in FIG. 24, when, for example, the operation node ND6 that receives an operation result from the already present predetermined operation node ND1 is added, it is determined whether or not the additional operation node ND6 can be allocated in the order of the Step 1, the Step 2, the Step 3, the Step 4, and the Step 5, from the fastest Step 1 to the latest Step 5, and the operation node ND6 is added to the Step 2 that is the fastest and the operation node ND6 can be allocated, thereby scheduling the operation node ND6 to the fastest Step as possible.

As shown in the data flow graph F11 of FIG. 24, when the operation nodes ND10 and ND11 that give the operation results to the operation nodes ND7 and ND8 are added, as explained above, it is determined whether or not the additional operation nodes ND10 and ND11 can be allocated in the order of the Step 5, the Step 4, the Step 3, the Step 2, and the Step 1, from the latest Step 5 to the fastest Step 1, and the operation nodes ND10 and ND11 are added to the Steps 2 and 3 that are the latest and such additional operation nodes can be allocated, thereby scheduling the operation nodes ND10 and ND11 to the latest steps as possible. Hence, according to the data flow graph F11 generated in this manner, both performance maximization and variable retaining period minimization are accomplished.

Next, an explanation will be given of a case in which an additional operation node is not allocatable even though determination on the possibility of allocating the additional operation node from the latest Step 5 to the fastest Step 1 is performed as explained above. Data flow graphs F15 and F16 shown in FIG. 25 represent scheduling of newly adding an operation node ND27 to be discussed later. The operation node ND27 receives the operation result of the operation node ND25, executes predetermined operation, and gives this operation result to the operation node ND23. Moreover, a data flow graph F15 shown in FIG. 25 represents a hard-wired logic part having Step A to Step C unmodifiable unlike FIG. 24.

In this case, when the additional operation node ND27 is added, as explained above, even if determination is made on whether or not the additional operation node ND27 can be allocated in the order from the Step C, the Step B, and the Step A, from the latest Step C to the fastest Step A, the operation node ND27 can be inserted in none of the Step C, the Step B, and the Step A. Hence, in this case, a new Step D is added between the Step B and the Step C, and scheduling is made so as to execute the operation of the additional operation node ND27 in the Step D.

When an operation node ND28 that gives the operation result to the operation node ND27 is further added to the data flow graph F16, since the Step B is the unmodifiable hard-wired logic part, the operation node ND27 cannot be allocated to the Step B. Accordingly, in this case, a new Step E is added between the Step B and the Step D, and scheduling is made so as to execute the operation of the additional operation node ND28 in the Step E. New patch states can be created for the data flow graphs F16 and F17 in this fashion.

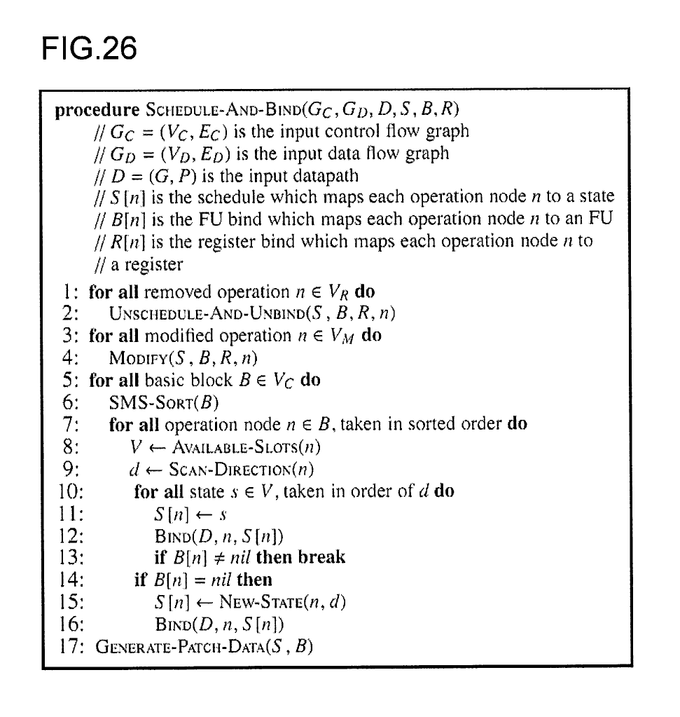

A scheduling algorithm shown in FIG. 26 indicates the above-explained algorithm that accomplishes both performance maximization and variable retaining period minimization. In FIG. 26, the order of scheduling is obtained in the SMS-SORT( ) function at the sixth line, and in this part, the Swing Modulo Scheduling algorithm is used which is disclosed in “J. Llosa. Swing modulo scheduling: A lifetime-sensitive approach, In Proc. IEEE Int. Conf. on Parallel Architecture and Compilation Techniques (PACT), pages 80-87, October 1996”.

An explanation of the scheduling algorithm shown in FIG. 26 will be given below. First of all, the scheduling and the binding at a deleted node Y_{R} in Δ-CDFG are invalidated to make the other operation nodes available (first to second lines in FIG. 26). Moreover, with respect to the changed node V_{M} of Δ-CDFG, scheduling and binding are performed as a new patch state (third to fourth lines in FIG. 26). Next, for each basic block B of Δ-CDFG, using the SMS-SORT( ) function of the Swing Modulo Scheduling algorithm, it is determined in which order the operation of the basic block B is scheduled (fifth to sixth lines in FIG. 26). The operation node n is scheduled in accordance with the order determined in this stage.

First, for each operation node n, all states s (Steps) that can schedule the operation node n through an AVAILABLE-SLOTS( ) function are obtained (seventh to eighth lines in FIG. 26). A SCAN-DIRECTION( ) function determines in what order the states s are scanned (i.e., whether or not the scanning is carried out from the latest state (Step) or from the fastest state (Step)). The states S are scanned one by one in the direction determined in this stage, and it is checked whether or not the binding is enabled in this state (10 to 13th lines in FIG. 26). At this time, if the binding is unable when all states are scanned, a new patch state is generated (NEW-STATE( )), and the binding is performed on this state (14 to 16th lines in FIG. 26). Finally, a patch memory data is generated with a newly scheduled and bound state as a patch state (i.e., an additional program counter) (17th line in FIG. 26, GENERATE-PATCH-DATA( )).

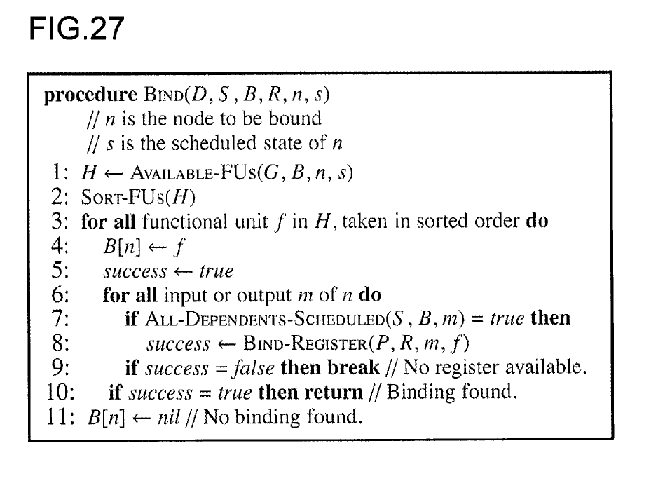

Next, FIG. 27 shows an algorithm for binding the function unit FU and the register. With respect to a scheduled operation node n, an AVAILABLE-FUs( ) function obtains all function units FU that can be bound to the operation node n. Next, a SORT-FUs( ) function sorts those function units FU based on costs. A cost when an operation node n is bound with a function unit f is the number of registers in the register file necessary at this time. Hence, it becomes possible to obtain a binding that does not use a register as much as possible.

After the sorting, the function unit f is tentatively bound in the order of sorting to the operation node n (third to fourth lines in FIG. 27). It is checked whether or not a corresponding operation node is already scheduled to each input/output of the operation node n. If it is scheduled, the register is bound so that data can be exchanged with those operation nodes (sixth to eighth lines in FIG. 27).

Conversely, when the normal registers (e.g., the above-explained distributed registers R1, R2, R3, and R4, etc.,) are unavailable, the register in the register file 17 is bound. If some of input/output operation nodes n are not scheduled yet, binding on the register is interrupted until scheduling of those operation nodes completes. When the binding of the register is successful, it returns to a SCHEDULE-AND-BIND( ) function. If the binding is unsuccessful, binding on another function unit FU is likewise attempted. The incremental scheduling-binding is performed in this manner to accomplish both performance maximization and variable retaining period minimization.

### (10) Accelerator with Trace Buffer

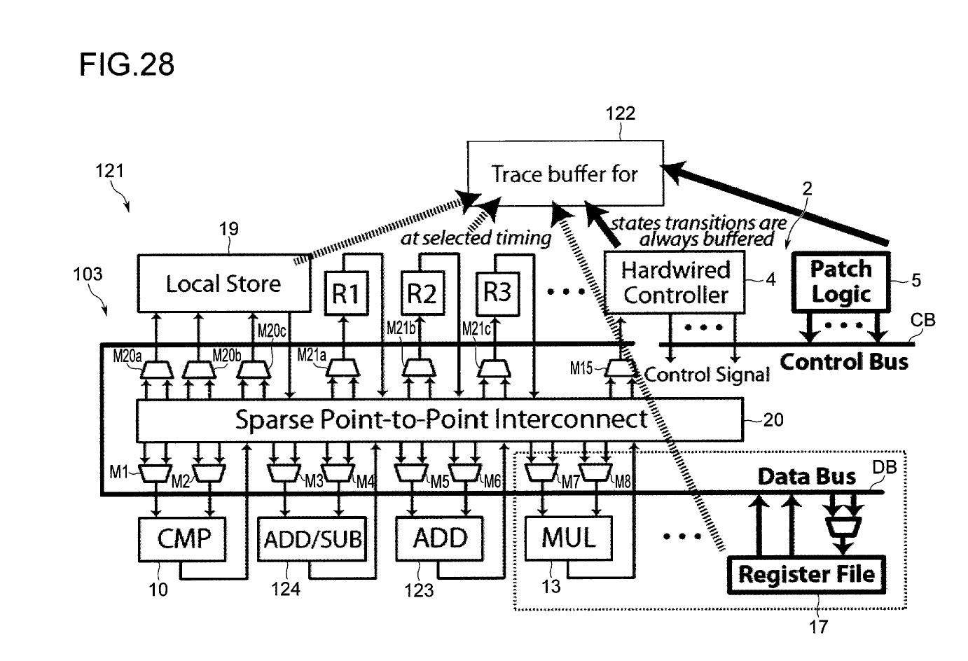

Next, an explanation will be given of an accelerator with a trace buffer according to the other embodiment. In FIG. 28, a reference numeral 121 indicates an accelerator according to the other embodiment which employs a configuration that a trace buffer 122 is coupled with a predetermined circuit. Like the conventional technology, it is necessary at the time of designing to determined to which one of the various function units (the comparator 10, the adder and subtractor 124, the adder 123, and the multiplier 13, etc.), the registers (the distributed registers R1, R2, and R3, . . . , etc., and the register file 17), and various control circuits, such as the integrated hard-wired logic controller 4, and the patch circuit 5 the trace buffer 122 should be coupled. However, regarding the internal signal of the function unit not directly coupled, such a signal can be indirectly output to the trace buffer 122 via a signal from the patch circuit 5.

According to the accelerator 121, the patch circuit 5 is controlled so as to utilize the value of the trace buffer 122 inversely as an internal signal as needed, and as a result, verification and debagging can be advanced while rewriting the value of the internal signal. Furthermore, according to this accelerator 121, by controlling the patch circuit 5, a timing at which the internal signal is stored in the trace buffer 122 and the kind of the internal signal to be stored can be specified. In addition, the patch circuit 5 has a function of dynamically modifying the condition of storing the internal signal in the trace buffer 122 by the value of the internal variable at the time of execution.

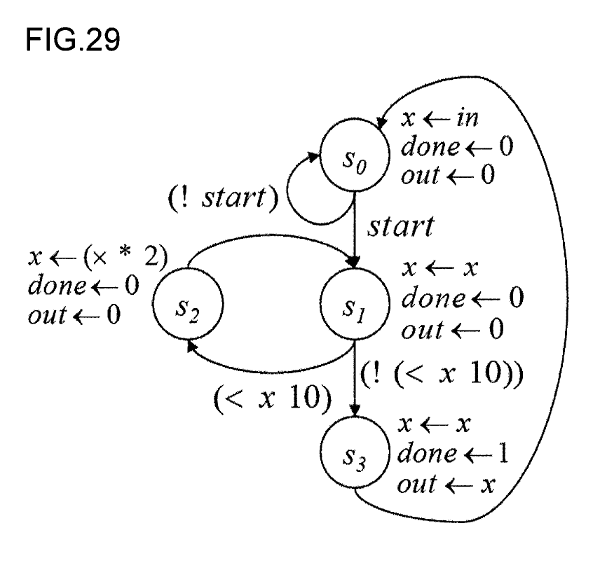

In general, the hardware design as shown in FIG. 28 is called an RTL (register transfer level), and can express the behavior thereof in the form of an FSMD (Finite State Machine with Datapath). FIG. 29 shows an illustrative FSMD. In this case, it begins from the initial state (in this example, s0), and the state transition occurs when a condition is satisfied, and a register transfer text described in the state transition is executed, and such successive operations are repeated for each cycle.

When the design is described in a high-level language like the C language, and the modifiable accelerator 121 automatically performs synthesis through a high-level synthesis, etc., an FSMD description shown in FIG. 29 can be automatically generated. Moreover, when the modifiable accelerator 121 is originally designed by the RTL, it can be directly used as it is. With respect to the FSMD, the state transition sequence (a sequence of s0, s1, s2, and s3 in the example shown in FIG. 29) at the time of execution is stored in the trace buffer 122, and thus useful information can be obtained at a little buffer quantity for verification and debagging.

In each state of the FSMD, there are two cases in which the state directly transitions to the next state as it is and whether or not the state transition satisfies a conditional expression. For example, when the ratio of both cases was examined for some typical designing, the ratio of states whose next states are unique among all states was equal to or greater than 90%. When the state transition sequence is traced, such tracing is unnecessary when the next state is uniquely set (since the next state can be determined from the present state), and the trace buffer 122 stores the sequence only when there are a plurality of next states.

The data to be stored can be only 1 bit indicating whether or not the condition is satisfied, and the trace buffer 122 can store a very long sequence. When, for example, the trace buffer 122 of 128 KB is used, providing that the state with conditional branches is 10% as a whole, 128*1000/0.1=1.28*10⁶ cycles can be traced. Accordingly, the behavior can trace across a very long cycle.

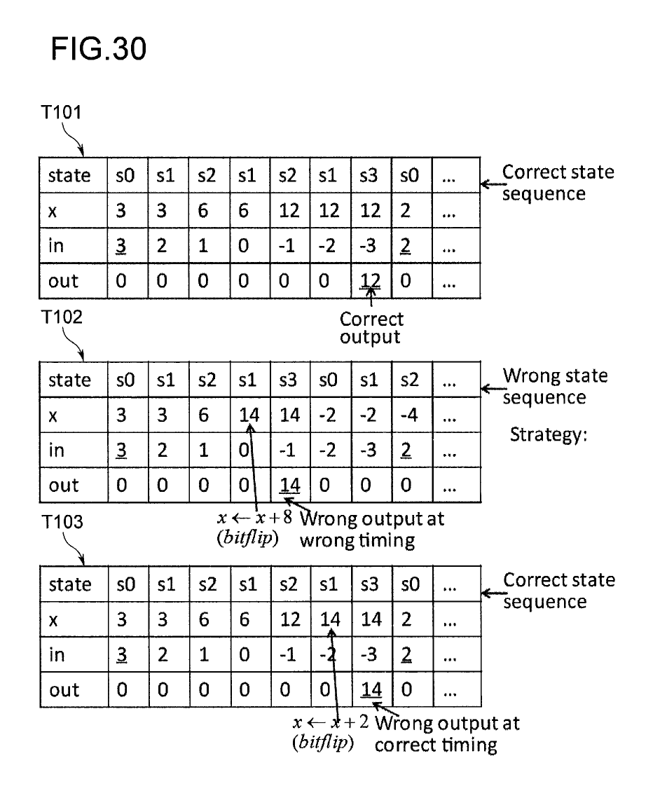

A first table T101 in FIG. 30 shows a behavior when there is no electrical error in the execution of the FSMD shown in FIG. 29, and a second table T102 and a third table T103 show behaviors when several electrical errors occur in the execution of the FSMD shown in FIG. 29. The accelerator 121 can store, in the trace buffer 122, trace information that are successive behavioral signals shown in, for example, such first table T101, second table T102, and third table T103. Hence, the designer can analyze a behavior in the execution of the FSMD by reading the trace information stored in the trace buffer 122 and referring to such read information through another computer, etc.

In practice, according to the first table T101, since s0 is “x←in, done←0, out←0” in the FSMD of FIG. 29, when, for example, “3” is input in the “in”, x becomes “3” and out becomes “0”. Since s1 is “x←x, done←0, out←0”, x becomes “3”, and out becomes “0”. In the case of s2, since it is “x←(x*2), done←0, out←0”, x becomes “6”, out becomes “0”, and x becomes “12” through s1 again. Moreover, s3 following s2 is “x←x, done←1, out←x”, x becomes “12” and out becomes “12”. As explained above, according to the first table T101, it can be analyzed that a correct output “12” is obtained in Out of the seventh cycle.

Conversely, according to the second table T102, the fourth bit of x at the fourth cycle is inverted by an electrical error, and a wrong value “14” is output to the out at the fifth cycle. Moreover, according to the third table T103, the second bit of x at the sixth cycle is inverted by an electrical error, and the out at the seventh cycle has an output like the case in which there is no error, but the output value is “14” and the wrong value is output. As explained above, according to the accelerator 121, such successive behavioral signals are stored as trace information in the trace buffer 122, so that the designer can analyze such an behavioral signal. Accordingly, a complicated analysis is necessary to specify the caused electrical error, but by using the modifiable accelerator 121 that can dynamically modify the behavior thereof, dramatically efficient verification and debagging are enabled. The flow of verification and debagging utilizing the modifiable accelerator 121 can be likewise applied to a post-silicon verification and debagging and verification and debagging in an emulation environment.

What is claimed is:

1. An accelerator comprising:
a control unit including a controller which is configured by a hard-wired logic with a prefixed logic, and which successively generates control signals that are instructions of predetermined arithmetic processing in accordance with a preset order of program counters; and
a data path that executes an operation in accordance with the arithmetic processing instruction through a plurality of function units based on the control signal from the control unit,
the control unit further including a patch circuit which replaces a predetermined program counter in the program counters with an additional program counter, and which transmits, to the data path, a control signal that is a modified arithmetic processing instruction associated with the additional program counter instead of the arithmetic processing instruction associated with the predetermined program counter, and
the data path is configured to execute an operation in accordance with the modified arithmetic processing instruction upon reception of the control signal from the patch circuit.

2. The accelerator according to claim 1, wherein
the patch circuit comprises:
a program counter patch that is capable of storing the additional program counter instead of a program counter to be executed next and associated with the program counter; and
a control signal patch that is capable of storing the modified arithmetic processing instruction associated with the additional program counter,
the program counter patch successively receives the program counter to be executed next from the controller, and transmits, to the control signal patch, the additional program counter instead of the program counter when the program counter is a program counter to be replaced with the additional program counter, and
the control signal patch transmits the control signal that is the modified arithmetic processing instruction associated with the additional program counter to the data path.

3. The accelerator according to claim 2, wherein
the patch circuit comprises a memory that stores the modified arithmetic processing instruction, and repeatedly generates control signals by predetermined times in a loop in a predetermined order defined by the program counters and the additional program counter, and
the memory is coupled to a patch memory, reads another modified arithmetic processing instruction different from the modified arithmetic processing instruction as needed from the patch memory, and generates a control signal indicating the another modified arithmetic processing instruction instead of the modified arithmetic processing instruction during the looped process.

4. The accelerator according to claim 1, wherein the controller employs a circuit configuration that enables a plurality of different functions.

5. The accelerator according to claim 1, wherein the data path is provided with, in addition to the function unit that is capable of executing an arithmetic processing in accordance with the control signal from the controller, an auxiliary function unit to be necessary to satisfy a performance constraint after a function modification performed on the control unit.

6. The accelerator according to claim 5, wherein
a virtual arithmetic processing to be executed based on the control signal from the control unit is changed within a predetermined range at random, and
the data path is provided with the auxiliary function unit necessary to execute the changed virtual arithmetic processing.

7. The accelerator according to claim 6, wherein
virtual change of the arithmetic processing is executed by predetermined times, and
the data path is provided with all of the auxiliary function units necessary for executing respective virtual arithmetic processing.

8. The accelerator according to claim 5, further comprising:
a plurality of distributed registers associated in advance with respective function units each executing the arithmetic processing; and
a register file coupled with all of the function units,
wherein an operation result obtained by the function unit is stored in the distributed register associated with the function unit, and when an arithmetic processing through the auxiliary function unit other than the function unit is necessary, an operation result obtained by the auxiliary function unit is stored in the register file.

9. The accelerator according to claim 1, further comprising a trace buffer that can store trace information which is the arithmetic processing instruction associated with the predetermined program counter among the program counters.

10. A data processing method executed by an accelerator, the accelerator comprising:
a control unit including a controller which is configured by a hard-wired logic with a prefixed logic, and which successively generates control signals that are instructions of predetermined arithmetic processing in accordance with a preset order of program counters; and
a data path that executes an operation in accordance with the arithmetic processing instruction through a function unit based on the control signal from the control unit,
the data processing method comprising:
a replacement step of causing a patch circuit provided in the control unit to replace a predetermined program counter in the program counters with an additional program counter;
a transmission step of causing the patch circuit to transmit a control signal that is a modified arithmetic processing instruction associated with the additional program counter to the data path instead of an arithmetic processing instruction associated with the program counter replaced with the additional program counter; and
an execution step of causing the data path to execute an operation in accordance with the modified arithmetic processing instruction.

11. The data processing method according to claim 10, wherein
in the replacement step, when a program counter patch provided in the patch circuit determines that the program counter to be executed next and received from the controller is the program counter to be replaced with the additional program counter, the additional program counter is transmitted to a control signal patch provided in the patch circuit instead of the program counter to be replaced, and
in the transmission step, the control signal patch reads the modified arithmetic processing instruction associated with the additional program counter from a memory, and transmits the read modified arithmetic processing instruction as the control signal to the data patch.

12. The data processing method according to claim 10, the data processing method repeating the replacement step, the transmission step and the execution step in a loop, reading another modified arithmetic processing instruction different from the modified arithmetic processing instruction as needed from a patch memory, storing the read another modified arithmetic processing instruction in the memory, and generating a control signal indicating the another modified arithmetic processing instruction during the looped process instead of the modified arithmetic processing instruction.

13. The data processing method according to claim 10, wherein the controller comprises a circuit configuration enabling a plurality of different functions, and realizes a predetermined function as needed.

14. The data processing method according to claim 10, wherein the data path executes the arithmetic processing through an auxiliary function unit to be necessary to satisfy a performance constraint after a function modification performed on the control unit in addition to a function unit capable of executing an arithmetic processing based on the control signal from the controller.

15. The data processing method according to claim 14, wherein
a virtual arithmetic process to be executed based on the control signal from the control unit is changed within a predetermined range at random, and
the auxiliary function unit provided for executing the changed virtual arithmetic processing executes the operation in accordance with the modified arithmetic processing instruction.

16. The data processing method according to claim 15, wherein
virtual change of the arithmetic processing is executed by predetermined times, and
the auxiliary function unit provided for executing each virtual arithmetic processing executes the operation in accordance with the modified arithmetic processing instruction.
